(19) United States
(12) Patent Application Publication
(10) Pub. No.: US 2013/0106377 A1
(43) Pub. Date: May 2, 2013

(54) CONTROL VOLTAGE DELAY DEVICE, DIGITAL POWER CONVERTER USING THE SAME, AND DRIVING METHOD THEREOF

(71) Applicant: FAIRCHILD KOREA SEMICONDUCTOR LTD., Bucheon (KR)

(72) Inventors: Sungpah LEE, Seoul (KR); Kunhee CHO, Seoul (KR); Duckki KWON, Incheon (KR)

(73) Assignee: FAIRCHILD KOREA SEMICONDUCTOR LTD., Bucheon (KR)

(21) Appl. No.: 13/659,640

(22) Filed: Oct. 24, 2012

(30) Foreign Application Priority Data
Oct. 31, 2011 (KR) 10-2011-0112448

(51) Int. Cl. G05F 1/10

(52) U.S. Cl. 323/282

(57) ABSTRACT

Exemplary embodiments relate to a control voltage delay device, a digital power converter, and a driving method of a digital power converter. The control voltage delay device generates an output clock signal and a reference clock signal for controlling an output voltage of the digital power converter. The control voltage delay device generates the output clock signal having an output delay to a clock signal according to the output voltage and the reference clock signal having a reference delay to the clock signal according to the reference voltage. The reference voltage is a target value of the output voltage.

### CROSS-REFERENCE TO RELATED APPLICATION

This application claims priority to and the benefit of Korean Patent Application No. 10-2011-0112448 filed in the Korean Intellectual Property Office on Oct. 31, 2011, the entire contents of which are incorporated herein by reference.

### BACKGROUND

(a) Field

Exemplary embodiments relate to receiving feedback of an output voltage for controlling the output voltage of the power converter and controlling an operation of a power converter.

(b) Description of the Related Art

A power converter receives feedback of information of an output voltage.

Hereafter, the information of the fed back output voltage is called feedback information.

The power converter operates according to the feedback information, and is maintained the output voltage uniformly.

Generally, a circuit for generating the feedback information applied to the power converter is an analog circuit.

An RC filter configured with a resistor and a capacitor generates the feedback information. The feedback information is affected by PVT (process, voltage, and temperature) variation of the RC filter.

This is because a coefficient of the resistor and a coefficient of the capacitor are vulnerable to PVT variation.

Also, when the resistor and the capacitor are integrated as a chip, the chip size may be increased.

Feedback information may be generated using an analog-digital converter (hereinafter, ADC), which transfers an output voltage to digital information, instead of the RC filter.

As a resolution of the ADC is increased, the output voltage input to the ADC can be transformed as a digital signal more accurately.

However, resolution of the ADC of a real power converter has a limit.

As resolution of the ADC is increased, power consumption of the ADC and the size of the ADC are increased so that the resolution of the ADC is limited.

Accordingly, it is difficult to generate accurate feedback information. In addition, the power consumption and the chip size must be considered when designing the feedback information generating circuit.

The above information disclosed in this Background section is only for enhancement of understanding of the background of the invention and therefore it may contain information that does not form the prior art that is already known in this country to a person of ordinary skill in the art.

### SUMMARY

An exemplary embodiment has been made in an effort to provide a digital power converter, and a driving method thereof, which is immune to a variation of PVT and is not limited in resolution, power consumption, and area.

Also, an exemplary embodiment provides a control voltage delay device used in the digital power converter and the driving method thereof.

A control voltage delay device according to an exemplary embodiment of various exemplary embodiments generates an output clock signal and a reference clock signal to control an output voltage of a digital power converter.

The control voltage delay device includes a first driver generating the output clock signal having an output delay to a clock signal according to the output voltage, and a second driver generating the reference clock signal having a reference delay to the clock signal according to the reference voltage. The reference voltage is a target value of the output voltage.

The first driver includes a first transistor including a gate electrode receiving the output voltage and a first terminal connected to a first voltage, an inverter connected between a second terminal of the first transistor and a second voltage and receiving the clock signal, a capacitor connected to an output terminal of the inverter, and an output inverter connected to the capacitor and the output terminal of the inverter.

An output of the output inverter is the output clock signal.

The inverter includes: a second transistor including a gate electrode where the clock signal is input and a first terminal connected to a second terminal of the first transistor; and a third transistor including a first terminal connected to a second terminal of the second transistor, a gate electrode receiving the clock signal, and a second terminal connected to the second voltage.

The output terminal of the inverter is connected to the second transistor and the third transistor.

The second driver includes: a fourth transistor including a gate electrode where the reference voltage is input and a first terminal connected to the first voltage; a first inverter connected between a second terminal of the fourth transistor and the second voltage and receiving the clock signal; a first capacitor connected to an output terminal of the first inverter; and a first output inverter connected to the first capacitor and the output terminal of the first inverter.

An output of the first output inverter is the reference clock signal.

The first transistor and the fourth transistor are N channel transistors, and the second voltage is higher than the first voltage.

In these conditions, the output delay is generated when the capacitor of the first driver is discharged by a sink current flowing through the first transistor of the first driver according to the output voltage, and the reference delay is generated when the first capacitor of the second driver is discharged by a sink current flowing through the fourth transistor of the second driver according to the reference voltage.

The first transistor and the fourth transistor are P channel transistors, and the second voltage is lower than the first voltage.

In these conditions, the output delay is generated when the capacitor of the first driver is charged by a source current flowing through the first transistor of the first driver according to the output voltage, and the reference delay is generated when the first capacitor of the second driver is charged by a source current flowing through the fourth transistor of the second driver according to the reference voltage.

A first driver according to an exemplary variation includes a fifth transistor including a gate electrode where the output voltage is input and a first terminal connected to a first voltage, a current mirror circuit connected with a second terminal of the first transistor and the second voltage and mirroring a current flowing through the first transistor, an inverter outputting an output of the current mirror circuit according to the clock signal, a capacitor connected to an output terminal of the inverter, and an output inverter connected to the capacitor and the output terminal of the inverter.

An output terminal of the output inverter is the output clock signal.

The current mirror circuit includes: a sixth transistor including a first terminal connected to a second terminal of the fifth transistor, a second terminal connected to the second voltage, and a gate electrode connected to the first terminal of the six transistor; and a seventh transistor including a gate electrode connected to the gate electrode of the sixth transistor, a first terminal connected to the second voltage, and a second terminal connected to the inverter.

The inverter includes an eighth transistor including a first terminal connected to the output of the current mirror circuit and a gate electrode where the clock signal is input, and a ninth transistor including a first terminal connected to the second terminal of the eighth transistor, a second terminal connected to the first voltage, and a gate electrode where the clock signal is input.

The output terminal of the inverter is connected to the eighth transistor and the ninth transistor.

A second driver according to an exemplary variation includes: a tenth transistor including a gate electrode where the reference voltage is input and a first terminal connected to the first voltage; a first current mirror circuit connected with a second terminal of the tenth transistor and the second voltage and mirroring a current flowing through the tenth transistor; a first inverter outputting an output of the first current mirror circuit according to the clock signal; a first capacitor connected to an output terminal of the first inverter; and a first output inverter connected to the first capacitor and the output terminal of the first inverter. An output of the first output inverter is the reference clock signal.

The fifth transistor and the tenth transistor are N channel transistors, and the second voltage is higher than the first voltage.

In these conditions, the output delay is generated when the capacitor of the first driver is charged by a source current generated by copying a current flowing through the fifth transistor of the first driver according to the output voltage. The reference delay is generated when the first capacitor of the second driver is charged by a source current generated by copying a current flowing through the tenth transistor of the second driver according to the reference voltage.

The fifth transistor and the tenth transistor are P channel transistors, and the second voltage is lower than the first voltage.

In these conditions, the output delay is generated when the capacitor of the first driver is discharged by a sink current generated by copying a current flowing through the fifth transistor of the first driver according to the output voltage. The reference delay is generated when the first capacitor of the second driver is discharged by a sink current generated by copying a current flowing through the tenth transistor of the second driver according to the reference voltage.

A first driver according to other exemplary variation includes a second capacitor having a capacity that is changed according to the output voltage, a second inverter including an output terminal connected to the second capacitor and an input terminal where the clock signal is input, and a second output inverter connected with the output terminal of the second inverter and the second capacitor. An output of the second output inverter is the output clock signal.

A second driver according to other exemplary variation includes a third capacitor having a capacity that is changed according to the reference voltage, a third inverter including an output terminal connected to the third capacitor and an input terminal where the clock signal is input, and a third output inverter connected with an output terminal of the third inverter and the third capacitor. An output of the third output inverter is the reference clock signal.

The clock signal is a signal for controlling an operation of the digital power converter.

A digital power converter according to another exemplary embodiment transforming from an input voltage to an output voltage includes a power switch controlling the transforming operation, a control voltage delay device generating an output clock signal having an output delay according to an output voltage to a clock signal controlling an operation of the digital power converter and a reference clock signal having a reference delay according to a reference voltage to the clock signal, a phase detector generating a phase detection signal according to a phase difference between the output clock signal and the reference clock signal, and a digital filter generating a digital pulse width control signal controlling a duty of the power switch according to the phase detection signal.

The phase detector includes a D flip-flop sampling the output clock signal at an edge time of the reference clock signal, and the phase detection signal is determined according to a result of the sampling.

The digital filter multiplies a differentiated phase detection signal by a differentiation gain to generate a first value, multiplies an integrated phase detection signal by an integration gain to generate a second value, multiplies the phase detection signal by a proportion gain to generate a third value, and sums the first value, the second value, and the third value to generate the digital pulse width control signal, and the differentiation gain, the integration gain, and the proportion gain are set according to a range of the digital pulse width control signal.

The digital power converter further includes a DPWM (digital pulse width modulator) controlling turn-on of the power switch according to the clock signal and turn-off of the power switch according to the digital pulse width control signal.

The control voltage delay device includes a first driver generating the output clock signal and a second driver generating the reference clock signal.

The first driver includes a first transistor including a gate electrode where the output voltage is input and a first terminal connected to a first voltage, an inverter connected between a second terminal of the first transistor and a second voltage and receiving the clock signal, a capacitor connected to an output terminal of the inverter, and an output inverter connected to the capacitor and the output terminal of the inverter.

The second driver includes a second transistor including a gate electrode where the reference voltage is input and a first terminal connected to the first voltage, a first inverter connected with a second terminal of the second transistor and the second voltage receiving the clock signal, a first capacitor connected to an output terminal of the first inverter, and a first output inverter connected to the first capacitor and the output terminal of the first inverter.

An output of the output inverter is the output clock signal and an output of the first output inverter is the reference clock signal.

The first transistor and the second transistor are N channel transistors, and the second voltage is higher than the first voltage.

In these conditions, the output delay is generated when the capacitor is discharged by a sink current flowing through the first transistor according to the output voltage, and the reference delay is generated when the first capacitor is discharged by a sink current flowing through the second transistor according to the reference voltage.

The first transistor and the second transistor are P channel transistors, and the second voltage is lower than the first voltage.

In these conditions, the output delay is generated when the capacitor is charged by a source current flowing through the first transistor according to the output voltage, and the reference delay is generated when the first capacitor is charged by a source current flowing through the second transistor according to the reference voltage.

The control voltage delay device includes a first driver generating the output clock signal and a second driver generating the reference clock signal.

The first driver includes a third transistor including a gate electrode where the output voltage is input and a first terminal connected to a first voltage, a current mirror circuit connected with a second terminal of the third transistor and a second voltage and mirroring a current flowing through the third transistor, an inverter outputting an output of the current mirror circuit according to the clock signal, a capacitor connected to an output terminal of the inverter, and an output inverter connected to the capacitor and the output terminal of the inverter.

The second driver includes a fourth transistor including a gate electrode receiving the reference voltage and a first terminal connected to the first voltage, a first current mirror circuit connected with a second terminal of the fourth transistor and the second voltage and mirroring a current flowing through the fourth transistor, a first inverter outputting an output of the first current mirror circuit according to the clock signal, a first capacitor connected to an output terminal of the first inverter, and a first output inverter connected to the first capacitor and the output terminal of the first inverter.

An output of the output inverter is the output clock signal and an output of the first output inverter is the reference clock signal.

The third transistor and the fourth transistor are N channel transistors, and the second voltage is higher than the first voltage.

In these conditions, the output delay is generated when the capacitor is charged by a source current flowing through the third transistor according to the output voltage, and the reference delay is generated when the first capacitor is charged by a source current flowing through the fourth transistor according to the reference voltage.

The third transistor and the fourth transistor are P channel transistors, and the second voltage is lower than the first voltage.

The output delay is generated when the capacitor is discharged by a sink current flowing through the third transistor according to the output voltage, and the reference delay is generated when the first capacitor is discharged by a sink current flowing through the fourth transistor according to the reference voltage.

A driving method of a digital power converter according to another exemplary embodiment transforming from an input voltage to an output voltage includes generating an output clock signal having an output delay according to the output voltage to a clock signal controlling an operation of the digital power converter, generating a reference clock signal having a reference delay to the clock signal according to the reference voltage, generating a phase detection signal according to a phase difference between the output clock signal and the reference clock signal, and controlling a duty of the power switch according to the phase detection signal.

According to the exemplary embodiments of the present invention, a digital power converter, and a driving method thereof, which is immune to a variation of PVT and is not limited in resolution, power consumption, and area can be provided. Also, a control voltage delay device used by the digital power converter, and the driving method thereof, can be provided.

### BRIEF DESCRIPTION OF THE DRAWINGS

FIG. 1 shows a digital power converter using a control voltage delay device according to an exemplary embodiment of the present invention.

FIG. 2A shows a circuit diagram of an example of a first driver according to an exemplary embodiment of the present invention.

FIG. 2B shows a circuit diagram of an example of a second driver according to an exemplary embodiment of the present invention.

FIG. 3 shows a waveform of a clock signal, an output clock signal, a reference clock signal, a phase detection signal, and an output voltage of a control voltage delay device embodied in the first driver and the second driver of FIGS. 2A and 2B.

FIG. 4A shows a circuit diagram of an exemplary variation of the first driver according to an exemplary embodiment of the present invention.

FIG. 4B shows a circuit diagram of an exemplary variation of the second driver according to an exemplary embodiment of the present invention.

FIG. 5 shows a waveform of a clock signal, an output clock signal, a reference clock signal, a phase detection signal, and an output voltage of a control voltage delay device embodied in the first driver and the second driver of FIGS. 4A and 4B.

FIG. 6A shows a circuit diagram of another exemplary variation of the first driver according to an exemplary embodiment of the present invention.

FIG. 6B shows a circuit diagram of another exemplary variation of the second driver according to an exemplary embodiment of the present invention.

FIG. 7 shows a waveform of a clock signal, an output clock signal, a reference clock signal, a phase detection signal, and an output voltage of a control voltage delay device embodied in the first driver and the second driver of FIGS. 6A and 6B.

FIG. 8A shows a circuit diagram of the first driver according to another exemplary embodiment of the present invention.

FIG. 8B shows a circuit diagram of a second driver according to the other exemplary embodiment of the present invention.

FIG. 9 shows a waveform of a clock signal, an output clock signal, a reference clock signal, a phase detection signal, and an output voltage of a control voltage delay device embodied in the first driver and the second driver of FIGS. 8A and 8B.

FIG. 10A shows a circuit diagram of an exemplary variation of the first driver according to the other exemplary embodiment of the present invention.

FIG. 10B shows a circuit diagram of an exemplary variation of the second driver according to the other exemplary embodiment of the present invention.

FIG. 11 shows a waveform of a clock signal, an output clock signal, a reference clock signal, a phase detection signal, and an output voltage of a control voltage delay device embodied in the first driver and the second driver of FIGS. 10A and 10B.

FIG. 12A shows a circuit diagram of another exemplary variation of the first driver according to the other exemplary embodiment of the present invention.

FIG. 12B shows a circuit diagram of another exemplary variation of the first driver according to the other exemplary embodiment of the present invention.

FIG. 13 shows a waveform of a clock signal, an output clock signal, a reference clock signal, a phase detection signal, and an output voltage of a control voltage delay device embodied in the first driver and the second driver of FIGS. 12A and 12B.

FIG. 14A shows a circuit diagram of an example of a control voltage delay device of a first driver according to another exemplary embodiment of the present invention.

FIG. 14B shows a circuit diagram of an example of a control voltage delay device of a second driver according to another exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive.

Like reference numerals designate like elements throughout the specification.

Throughout this specification and the claims that follow, when it is described that an element is “coupled” to another element, the element may be “directly coupled” to the other element or “electrically coupled” to the other element through a third element.

In addition, unless explicitly described to the contrary, the word “comprise” and variations such as “comprises” or “comprising” will be understood to imply the inclusion of stated elements but not the exclusion of any other elements.

Hereinafter, referring to drawings, an exemplary embodiment of the present invention is explained.

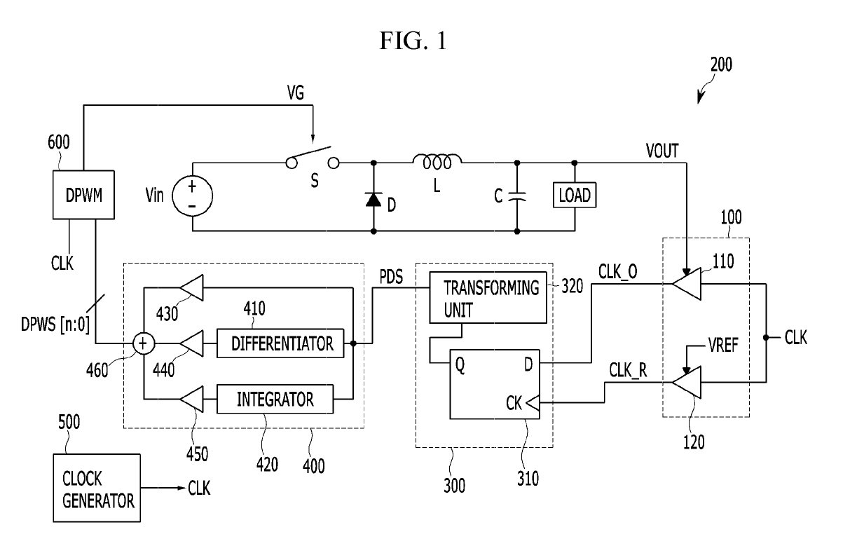

FIG. 1 shows a digital power converter using a control voltage delay device according to an exemplary embodiment of the present invention.

As shown in FIG. 1, a control voltage delay device 100 receives output a voltage VOUT of a digital power converter 200 and a clock signal CLK.

The clock signal CLK controls an operation of the digital power converter 200. More particularly, the clock signal CLK may control a switching operation of the digital power converter.

The control voltage delay device 100 transforms a difference between a reference voltage VREF and an output voltage VOUT to a phase difference of an output clock signal CLK_O and a reference clock signal CLK_R. The reference voltage VREF is a target voltage of the output voltage VOUT.

The phase difference may be utilized as feedback information which is necessary for the digital power converter 200 to control the output voltage VOUT.

The control voltage delay device 100 synchronizes with the clock signal CLK and generates the output clock signal CLK_O having an output delay according to the output voltage VOUT and the reference clock signal CLK_R having a reference delay according to the reference voltage VREF.

A first driver 110 generating the output clock signal CLK_O and a second driver 120 generating the reference clock signal CLK_R have different inputs but the same configuration.

The first driver 110 and the second driver 120 will be described.

The digital power converter 200 transforms an input voltage VIN to the output voltage VOUT.

The digital power converter 200 according to an exemplary embodiment of the present invention includes a buck converter embodied in a power switch S, a diode D, an inductor L, and a capacitor C. However, the embodiment of the present invention is not limited thereto, and the digital power converter 200 can be embodied in any of all types of converters.

The digital power converter 200 includes the control voltage delay device 100, a phase detector 300, a digital filter 400, a clock generator 500, and a digital pulse width modulator (hereinafter, DPWM) 600.

The digital power converter 200 transforms the input voltage VIN to the output voltage VOUT according to the switching operation of the power switch S.

A first terminal of the power switch S is connected to the input voltage VIN, and a second terminal of the power switch S is connected with a cathode of the diode D and a first terminal of the inductor L.

A second terminal of the inductor L is connected with a first terminal of the capacitor C and a load LOAD, and a second terminal of the capacitor C is connected to an anode of the diode D.

During a period when the power switch S is turned on, a current flows from the input voltage VIN to the capacitor C and the load LOAD through the inductor L.

During the turn-on period, the current flowing through the inductor L is increased and energy is stored to the inductor L.

During a period when the power switch S is turned off, a current flowing through the inductor L flows through the capacitor C and the diode D.

During the turn-off period, energy stored the inductor L is decreased and the current flowing through the inductor L is decreased.

The digital power converter 200 increases a duty cycle of the power switch S when the output voltage VOUT is decreased and is smaller a desired value, and decreases a duty cycle of the power switch S when the output voltage VOUT is increased and is larger the desired value.

The digital power converter 200 uses the phase difference of the output clock signal CLK_O and the reference clock signal CLK_R for sensing an increase or a decrease of the output voltage VOUT. The control voltage delay device 100 generates the output clock signal CLK_O and the reference clock signal CLK_R.

The phase detector 300 generates a phase detection signal PDS which is a digital signal according to the phase difference of the output clock signal CLK_O and the reference clock signal CLK_R.

The phase detector 300, as shown in FIG. 1, includes a D flip-flop 310 and a transforming unit 320.

The output clock signal CLK_O is input to an input terminal D of the D flip-flop 310 and the reference clock signal CLK_R is input to a clock terminal CK of the D flip-flop 310.

The D flip-flop 310 determines an output according to a logical level of an input signal of the input terminal D at a rising edge time of an input signal of the clock terminal CK, and outputs the output through an output terminal Q.

If the output clock signal CLK_O is a high level at a rising edge time of the reference clock signal CLK_R, a phase of the output clock signal CLK_O is led to a phase of the reference clock signal CLK_R.

At this time, an output of the D flip-flop 310 is a high level voltage corresponding to a logical level “1”.

On the contrary, if the output clock signal CLK_O is a low level at a rising edge time of the reference clock signal CLK_R, a phase of the output clock signal CLK_O lags behind a phase of the reference clock signal CLK_R.

At this time, an output of the D flip-flop 310 is a low level voltage corresponding to a logical level “0”.

The digital power converter 200 controls the output voltage VOUT so that a phase of the output clock signal CLK_O is coincident with a phase of the reference clock signal CLK_R.

The transforming unit 320 receives the output of the D flip-flop 310 and generates the phase detection signal PDS corresponding to the output of the D flip-flop 310.

According to an exemplary embodiment of the present invention, the phase detection signal PDS is a digital signal “1” when the output of the D flip-flop 310 is a high level voltage and a digital signal “−1” when the output of the D flip-flop 310 is a low level voltage.

The digital filter 400 generates a digital pulse width control signal DPWS[n:0] controlling a duty cycle of power switch S according to the phase detection signal PDS.

The digital filter 400 increases the digital pulse width control signal DPWS[n:0] to a predetermined first unit when the phase detection signal PDS is 1, and decreases the digital pulse width control signal DPWS[n:0] to a predetermined second unit when the phase detection signal PDS is −1.

For example, a range of the digital pulse width control signal DPWS[n:0] being an n-bit signal is from 1 to 100, the first unit is 1, and the second unit is 1. When the phase detection signal PDS is 1, the digital pulse width control signal DPWS[n:0] is increased by 1, while when the phase detection signal PDS is −1, the digital pulse width control signal DPWS[n:0] is decreased by 1.

The above is only an example to explain an exemplary embodiment of the present invention. The present invention is not limited thereto, and a range of the digital pulse width control signal DPWS[n:0] can be set an appropriate value according to an input range of the DPWM 600.

According to an exemplary embodiment of the present invention, the digital filter 400 is embodied by using a PID (proportional integral differential) filter, but the present invention is not limited thereto.

Another type of digital filter may be used to control the digital pulse width control signal DPWS[n:0] according to the phase detection signal PDS.

The digital filter 400 includes a differentiator 410, an integrator 420, a proportional gain unit 430, a differential gain unit 440, an integral gain unit 450, and an adder 460.

The differentiator 410 receives and differentiates the phase detection signal PDS, and the differential gain unit 440 multiplies an output of the differentiator 410 by a predetermined differential gain and outputs the multiplied output of the differentiator 410.

The integrator 420 receives and integrates the phase detection signal PDS, and the integral gain unit 450 multiplies an output of the integrator 420 by a predetermined integral gain and outputs the multiplied output of the integrator 420.

The proportional gain unit 430 receives the phase detection signal PDS, multiplies the phase detection signal PDS by a predetermined proportional gain, and outputs the multiplied phase detection signal PDS.

The differential gain, the integral gain, and the proportional gain are set according to a range of the digital pulse width control signal DPWS[n:0].

The range of the digital pulse width control signal DPWS[n:0] is set according to the input range of the DPWM 600. Therefore, the input range of DPWM 600 is considered for setting the differential gain, the integral gain, and the proportional gain.

According to the digital pulse width control signal DPWS[n:0] generated by PID filtering the phase detection signal PDS, the output voltage VOUT can be stably and rapidly converged to the reference voltage VREF.

The clock generator 500 generates the clock signal CLK to control a switching operation of the power switch S.

The switching frequency of power switch S is controlled by the clock signal CLK.

For example, at a rising time point of the clock signal CLK, the power switch S may be turned on.

The DPWM 600 controls to turn on the power switch S according to the clock signal CLK and turn off the power switch S according to the digital pulse width control signal DPWS[n:0].

For example, the DPWM 600 generates a gate signal VG which turns on the power switch S according to the clock signal CLK and turns off the power switch S according to the digital pulse width control signal DPWS[n:0].

More details, the DPWM 600 generates an enable level gate signal VG to turn on the power switch S in synchronization with the rising time point of the clock signal CLK. The DPWM 600 generates a disable level gate signal VG to turn off the power switch S after passing a time corresponding to a duty cycle determined according to the digital pulse width control signal DPWS[n:0] from the turn-on time of the power switch S.

According to exemplary embodiments of the present invention, the first driver 110 can include a current source according to the output voltage VOUT or a variable capacitor having variable capacity according to the output voltage VOUT.

According to exemplary embodiments of the present invention, the second driver 120 can include a current source generating a current according to the reference voltage VREF or a capacitor having a capacity according to the reference voltage VREF.

Firstly, an exemplary embodiment in which the first driver 110 includes a variable current source will be described.

The first driver 110 can include one of a variable sink current source according to the output voltage VOUT and a variable current source according to the output voltage VOUT, or two variable current sources.

Also, the variable current source may have a positive characteristic to increase a current according to the increase of the output voltage VOUT and decrease a current according to the decrease of the output voltage VOUT.

Alternatively, the variable current source may have a negative characteristic to decrease a current according to the increase of the output voltage VOUT and increase a current according to the decrease of the output voltage VOUT.

The first driver 110 embodied in a variable current source according to a positive characteristic will be described.

For example, the first driver 110 including a variable sink current source according to a positive characteristic will be described.

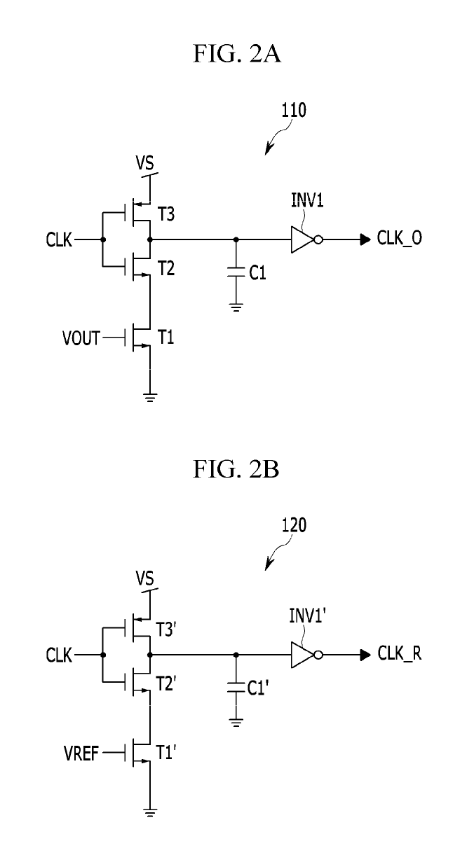

FIG. 2A shows a circuit diagram of an example of a first driver according to an exemplary embodiment of the present invention.

FIG. 2B shows a circuit diagram of an example of a second driver according to an exemplary embodiment of the present invention.

As shown in FIGS. 2A and 2B, an input of the first driver 110 is the output voltage VOUT, and an input of the second driver 120 is the reference voltage VREF. Components of the second driver 120 and connections between components thereof are the same as those of the first driver 110 excluding the input voltage.

Therefore, the second driver 120 is not described in detail.

As shown in FIG. 2A, the first driver 110 includes three transistors T1-T3, a capacitor C1, and an output inverter INV1.

The transistor T1 is a variable sink current source generating a sink current according to the output voltage VOUT.

The output voltage VOUT is input to a gate electrode of the transistor T1.

A drain electrode of the transistor T1 is connected to a source electrode of the transistor T2, and a source electrode of the transistor T1 is grounded.

The transistor T2 and the transistor T3 receiving the clock signal CLK to each gate electrode configures an inverter, a drain electrode of the transistor T2 and a drain electrode of the transistor T3 are connected, and a source electrode of the transistor T3 is connected to a voltage VS.

The transistor T3 is a P channel transistor, and the transistors T1 and T2 are N channel transistors.

A current having a positive characteristic according to the output voltage VOUT flows through transistor T1.

The capacitor C1 is connected to the drain electrode of the transistor T2 and the drain electrode of the transistor T3.

Accordingly, during the turn-on of the transistor T2, the capacitor C1 is discharged by the current flowing through the transistor T1, and during the turn-on of the transistor T3, the voltage VS is applied to the capacitor C1 through the transistor T3.

An input terminal of the output inverter INV1 is connected to the capacitor C1. The output inverter INV1 inverts a voltage of the capacitor C1 and outputs it as the output clock signal CLK_O.

It takes a period for an output phase of the output inverter INV1 to be inverted by discharge of the capacitor C1.

Accordingly, there is an output delay between a rising edge time of the clock signal CLK and a rising edge time of the output clock signal CLK_O.

Also, there is a reference delay between the rising edge time of the clock signal CLK and a rising edge time of the reference clock signal CLK_R.

The control voltage delay device 100 generates the output clock signal CLK_O having the output delay in synchronization with a rising edge of the clock signal CLK. The control voltage delay device 100 generates the reference clock signal CLK_R having the reference delay in synchronization with a rising edge of the clock signal CLK.

At a falling edge of the clock signal CLK, the reference clock signal CLK_R and the output clock signal CLK_O have no delay.

At the falling edge of the clock signal CLK, the transistors T3 and T3′ are turn on, the voltage VS is directly input to the output inverters INV1 and INV1′, and the reference clock signal CLK_R and the output clock signal CLK_O are falling at the falling edge time of the clock signal CLK.

As above, according to an exemplary embodiment of the present invention, the control voltage delay device 100 generates the output clock signal CLK_O having an output delay corresponding to the output voltage VOUT from the rising edge time of the clock signal CLK and the reference clock signal CLK_R having a reference delay corresponding to the reference voltage VREF from the rising edge time of the clock signal CLK.

Accordingly, the control voltage delay device 100 can transform a voltage difference of the output voltage VOUT and the reference voltage VREF to a phase difference between the rising edge of the output clock signal CLK_O and the rising edge of the reference clock signal CLK_R.

That is, if the output voltage VOUT is higher than the reference voltage VREF, a current flowing through the transistor T1 of the first driver 110 is larger than a current flowing through the transistor T1′ of the second driver 120.

Accordingly, the capacitor C1 of the first driver 110 is discharged more rapidly than a capacitor C1′ of the second driver 120 and the output clock signal CLK_O rises before rising of the reference clock signal CLK_R.

That it, the rising edge of the output clock signal CLK_O is led to the rising edge of the reference clock signal CLK_R.

Alternatively, if the output voltage VOUT is lower than the reference voltage VREF, a current flowing through the transistor T1 of the first driver 110 is smaller than a current flowing through the transistor T1′ of the second driver 120.

Accordingly, the capacitor C1 of the first driver 110 is discharged more slowly than the capacitor C1′ of the second driver 120 and the output clock signal CLK_O rises after rising of the reference clock signal CLK_R.

That is, the rising edge of the output clock signal CLK_O lags behind the rising edge of the reference clock signal CLK_R.

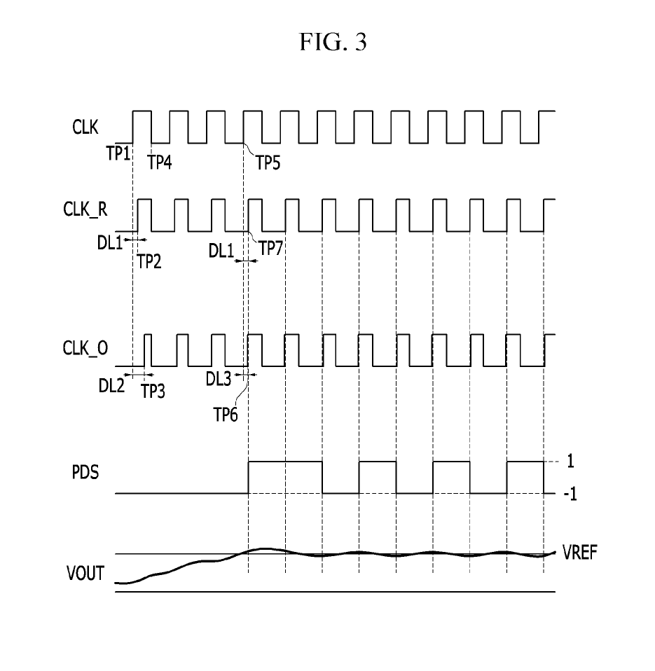

FIG. 3 shows a waveform of a clock signal, an output clock signal, a reference clock signal, a phase detection signal, and an output voltage of a control voltage delay device embodied in the first driver and the second driver of FIGS. 2A and 2B.

FIG. 3 shows a waveform of a predetermined period including a period in which an output voltage is increased and stabilized to a reference voltage.

Firstly, at a time point TP1, when the clock signal CLK is rising, the transistor T2 is turned on and the capacitor C1 is discharged by a sink current corresponding to the output voltage VOUT.

At the time point TP1, since the output voltage VOUT is lower than the reference voltage VREF, the sink current of the second driver 120 is larger than the sink current of the first driver 110.

Accordingly, the capacitor C1′ of the second driver 120 is discharged more rapidly than the capacitor C1 of the first driver 110, and a rising time point TP2 of the reference clock signal CLK_R is ahead of a rising time point TP3 of the output clock signal CLK_O.

That is, a reference delay DL1 is shorter than an output delay DL2.

The output clock signal CLK_O is a low level at the rising edge time point TP2 of the reference clock signal CLK_R, so the output of the D flip-flop 310 is a low level and the transforming unit 320 generates −1 as the phase detection signal PDS.

At a time point TP4, when the clock signal CLK is falling, the transistors T3 and T3′ are turned on and the output clock signal CLK_O and the reference clock signal CLK_R are falling.

During a period in which the output voltage VOUT is smaller than the reference voltage VREF, the rising edge of the output clock signal CLK_O is later than the rising edge of the reference clock signal CLK_R, so the phase detection signal PDS is maintained as −1.

At a rising time point TP5 of the clock signal CLK, the output voltage VOUT is higher than the reference voltage VREF.

Accordingly, the sink current of the first driver 110 is larger than the sink current of the second driver 120, and a rising edge time point TP6 of the output clock signal CLK_O is ahead of a rising edge time point TP7 of the reference clock signal CLK_R.

An output delay DL3 is shorter than the reference delay DL1.

The output clock signal CLK_O is a high level at the rising edge time point TP7 of the reference clock signal CLK_R, so that the output of the D flip-flop 310 is a high level and the transforming unit 320 generates 1 as the phase detection signal PDS.

As described above, at the rising edge time point of the clock signal CLK, according to a voltage difference of the output voltage VOUT and the reference voltage VREF, a phase difference of the output clock signal CLK_O and the reference clock signal CLK_R occurs.

The phase detection signal PDS occurs according to a level of the output clock signal CLK_O at the rising edge time point of the reference clock signal CLK_R.

When the phase detection signal PDS is −1, the digital filter 400 decreases the digital pulse width control signal DPWS[n:0], and when the phase detection signal PDS is 1, the digital filter 400 increases the digital pulse width control signal DPWS[n:0].

According to an exemplary embodiment of the present invention, the DPWM 600 decreases a duty cycle by the digital pulse width control signal DPWS[n:0] from a maximum duty cycle.

Accordingly, the more the digital pulse width control signal DPWS[n:0] is decreased, the more the duty cycle is increased.

During a period in which the output voltage VOUT increases to the reference voltage VREF, the duty cycle is increased since the phase detection signal PDS is −1.

Further, after the output voltage VOUT reaches the reference voltage VREF, the duty cycle is maintained within a constant range since the phase detection signal PDS alternately has 1 and −1 values.

According to an exemplary embodiment of the present invention, the first and second drivers are not limited to the circuit shown in FIGS. 2A and 2B.

For example, the first and second drivers can include a variable current source generating a source current according to the output voltage VOUT with a variable sink current source.

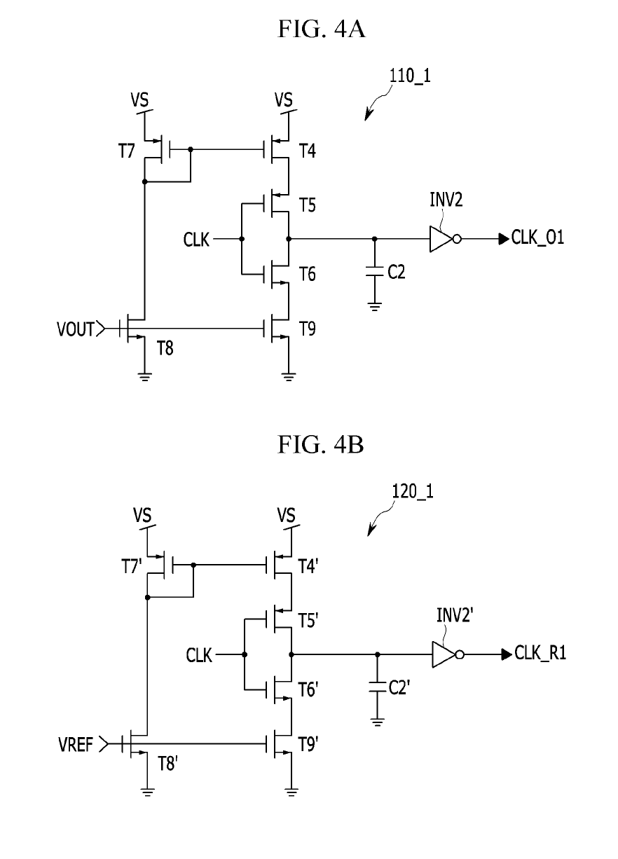

Hereinafter, referring to FIGS. 4A and 4B, a control voltage delay device configured with a first driver and a second driver including a variable current source and a variable sink current source will be described.

FIG. 4A shows a circuit diagram of an exemplary variation of the first driver according to an exemplary embodiment of the present invention.

FIG. 4B shows a circuit diagram of an exemplary variation of the second driver according to an exemplary embodiment of the present invention.

As shown in FIGS. 4A and 4B, the first driver 110_1 and the second driver 120_1 include a variable sink current source and a variable current source according to a positive characteristic.

The control voltage delay device including the first driver 110_1 and the second driver 120_1 generates a reference clock signal CLK_R1 and an output clock signal CLK_O1 having delays in synchronization with each of a rising edge of the clock signal CLK and a falling edge of the clock signal CLK.

The first driver 110_1 includes six transistors T4-T9, a capacitor C2, and an output inverter INV2.

The input of the second driver 120_1 that is different from the first driver 110_1 is the reference voltage VREF instead of the output voltage VOUT.

However, the second driver 120_1 has the same configurations and connections as the first driver 110_1 with the exception of the input.

Therefore, the second driver 120_1 is not described in detail.

A transistor T9 is a variable sink current source generating a sink current according to the output voltage VOUT.

A transistor T8, a transistor T7, and a transistor T4 form a variable current source generating a source current according to the output voltage VOUT.

The transistor T9 and a transistor T8 are N channel transistors, and the output voltage VOUT is connected with gate electrodes of the transistor T9 and the transistor T8.

Accordingly, a current flowing through the transistor T9 and the transistor T8 has a positive characteristic according to the output voltage VOUT.

The transistor T7 and the transistor T4 form a current mirror circuit.

The transistor T7 includes a source electrode connected to the voltage VS, a gate electrode connected to a gate electrode of the transistor T4, and a drain electrode connected to a drain electrode of the transistor T8.

Additionally, the drain electrode and the source electrode of the transistor T7 are connected with each other.

A source electrode of the transistor T4 is connected to the voltage VS, and a current flowing through the transistor T7 is copied by the current mirror circuit and flows through the transistor T4.

Since a current flowing through the transistor T8 flows through the transistor T7, a current having a positive characteristic according to the output voltage VOUT is copied and flows through the transistor T4.

As described above, the variable current source is configured.

The transistor T5 and transistor T6 configure an inverter, and the clock signal CLK is input to gate electrodes of the transistor T5 and transistor T6. A source electrode of the transistor T5 is connected to a drain electrode of the transistor T4, and a drain electrode of the transistor T6 is connected to a drain electrode of the transistor T9.

Since the transistor T5 is a P channel transistor, the transistor T5 is turned on by a low level clock signal CLK, and since the transistor T6 is an N channel transistor, the transistor T6 is turned on by the high level clock signal CLK.

The capacitor C2 is connected to a node connected with the drain electrode of the transistor T5 and the drain electrode of the transistor T6.

Accordingly, during the turn-on of the transistor T5, the capacitor C2 is charged by the current flowing through the transistor T4, and during the turn-on of the transistor T6, the capacitor C2 is discharged by a current flowing through the transistor T9.

An output inverter INV2 receives a voltage of the capacitor C2 and inverts the voltage of the capacitor C2, and outputs it as the output clock signal CLK_O1.

It takes time for an output phase of the output inverter INV2 to be inverted by a charge or discharge of the capacitor C2.

Accordingly, there is an output delay between a rising edge or a falling edge of the clock signal CLK and a rising edge or a falling edge of the output clock signal CLK_O1.

In the same way, there is a reference delay between the clock signal CLK and the reference clock signal CLK_R1 in the second driver 120_1.

That is, there is a reference delay between a rising edge or a falling edge of the clock signal CLK and a rising edge or a falling edge of the reference clock signal CLK_R1.

The output delay between the clock signal CLK and the output clock signal CLK_O1 occurs at the rising edge time point and the falling edge time point, and the reference delay between the clock signal CLK and the reference clock signal CLK_R1 occurs at the rising edge time point and the falling edge time point.

The control voltage delay device 100 generates a difference between the output delay and the reference delay according to a voltage difference of the output voltage VOUT and the reference voltage VREF. That is, the control voltage delay device 100 transfers the voltage difference of the output voltage VOUT and the reference voltage VREF as a phase difference of the output clock signal CLK_O1 and the reference clock signal CLK_R1.

That is, if the output voltage VOUT is higher than the reference voltage VREF, currents respectively flowing through the transistor T9 and the transistor T4 of the first driver 110_1 are larger than currents respectively flowing through the transistor T9′ and the transistor T4′ of the second driver 120_1.

Accordingly, the output delay is shorter than the reference delay, and a phase of the output clock signal CLK_O1 is ahead of a phase of the reference clock signal CLK_R1.

Alternatively, if the output voltage VOUT is lower than the reference voltage VREF, currents respectively flowing through the transistor T9 and the transistor T4 of the first driver 110_1 are smaller than currents respectively flowing through the transistor T9′ and the transistor T4′ of the second driver 120_1.

Accordingly, the output delay is longer than the reference delay, and a phase of the output clock signal CLK_O1 lags behind a phase of the reference clock signal CLK_R1.

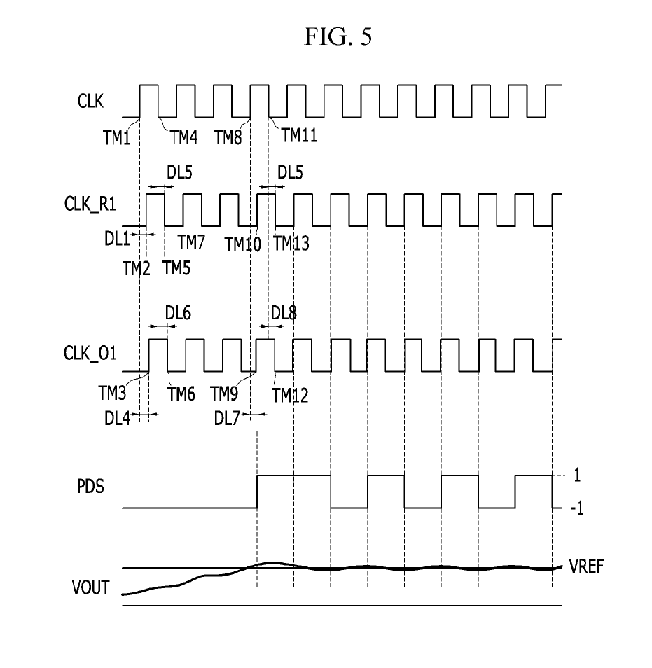

FIG. 5 shows a waveform of a clock signal, an output clock signal, a reference clock signal, a phase detection signal, and an output voltage of a control voltage delay device embodied in the first driver and the second driver of FIGS. 4A and 4B.

FIG. 5 shows a waveform of a predetermined period including a period in which an output voltage is increased and stabilized to the reference voltage.

First, at a time TM1, when the clock signal CLK is rising, the transistor T6 is turned on and the capacitor C2 is discharged by a sink current corresponding to the output voltage VOUT.

At the time TM1, since the output voltage VOUT is lower than the reference voltage VREF, the sink current of the second driver 120_1 is larger than the sink current of the first driver 110_1.

Accordingly, the capacitor C2′ of the second driver 120_1 is discharged more rapidly than the capacitor C2 of the first driver 110_1, and a rising time TM2 of the reference clock signal CLK_R1 is ahead of a rising time TM3 of the output clock signal CLK_O1.

That is, a reference delay DL1 is shorter than an output delay DL4.

At a time TM4, when the clock signal CLK is falling, the transistor T5 is turned on and the capacitor C2 is charged by the source current corresponding to the output voltage VOUT.

At the time TM4, since the output voltage VOUT is lower than the reference voltage VREF, the source current of the second driver 120_1 is larger than the source current of the first driver 110_1.

Accordingly, the capacitor C2′ of the second driver 120_1 is more rapidly charged than the capacitor C2 of the first driver 110_1 and at a falling time TM5 of the reference clock signal CLK_R1 is ahead of a falling time TM6 of the output clock signal CLK_O1.

That is, a reference delay DL5 is shorter than an output delay DL6.

The reference delay DL1 between a rising edge of the clock signal CLK and a rising edge of the reference clock signal CLK_R1 is constant, and the reference delay DL5 between a falling edge of the clock signal CLK and a falling edge of the reference clock signal CLK_R1 is constant

The reference delay DL1 can be same as the reference delay DL5.

At the rising edge time TM2 of the reference clock signal CLK_R1, the output clock signal CLK_O1 is a low level, so that the output of the D flip-flop 310 is a low level and the transforming unit 320 generates −1 as the phase detection signal PDS.

At a next rising edge time TM7 of the reference clock signal CLK_R1, the output clock signal CLK_O1 is a low level, so that the output of the D flip-flop 310 is a low level and the transforming unit 320 generates −1 as the phase detection signal PDS.

At a rising edge time TM8 of the clock signal CLK, the output voltage VOUT is higher than the reference voltage VREF.

Accordingly, the sink current of the first driver 110_1 is larger than the sink current of the second driver 120_1, and a rising edge time TM9 of the output clock signal CLK_O1 is ahead of a rising edge time TM10 of the reference clock signal CLK_R1.

An output delay DL7 is shorter than the reference delay DL1.

At the rising edge time TM10 of the reference clock signal CLK_R1, the output clock signal CLK_O1 is a high level, so that the output of the D flip-flop 310 is a high level and the transforming unit 320 generates 1 as the phase detection signal PDS.

At a falling edge time TM11 of the clock signal CLK, the output voltage VOUT is higher than the reference voltage VREF.

Accordingly, the source current of the first driver 110_1 is larger than the source current of the second driver 120_1, and a falling edge time TM12 of the output clock signal CLK_O1 is ahead of a falling edge time TM13 of the reference clock signal CLK_R1.

An output delay DL8 is shorter than the reference delay DL5.

As described above, at the rising edge time and the falling edge time of the clock signal CLK, according to a voltage difference of the output voltage VOUT and the reference voltage VREF, a phase difference of the output clock signal CLK_O1 and the reference clock signal CLK_R1 occurs.

When the phase detection signal PDS is −1, the digital filter 400 decreases the digital pulse width control signal DPWS[n:0], and when the phase detection signal PDS is 1, the digital filter 400 increases the digital pulse width control signal DPWS[n:0].

According to an exemplary embodiment of the present invention, the DPWM 600 decreases a duty by the digital pulse width control signal DPWS[n:0] from a maximum duty.

Accordingly, the more the digital pulse width control signal DPWS[n:0] is decreased, the more the duty is increased.

During a period in which the output voltage VOUT increases to reach the reference voltage VREF, since the phase detection signal PDS is −1, the duty is increased.

Further, after the output voltage VOUT reaches the reference voltage VREF, since the phase detection signal PDS alternately has 1 and −1 values, the duty is maintained with a constant range.

FIG. 5 shows that the phase detection signal PDS is determined according to a level of the output clock signal CLK_O1 at the rising edge time of reference clock signal CLK_R1, but the present invention is not limited thereto.

That is, a sampling time of the output clock signal can be a falling edge time of the reference clock signal instead of a rising edge time of the reference clock signal.

In more detail, according to a level of the output clock signal CLK_O1 at a falling edge time of the reference clock signal CLK_R1, the phase detection signal PDS is determined. And then, the phase detection signal PDS can have a phase contrary to that of the waveform shown in FIG. 5.

Then, the DPWM 600 may be designed to increase a duty by the digital pulse width control signal DPWS[n:0] from minimum duty.

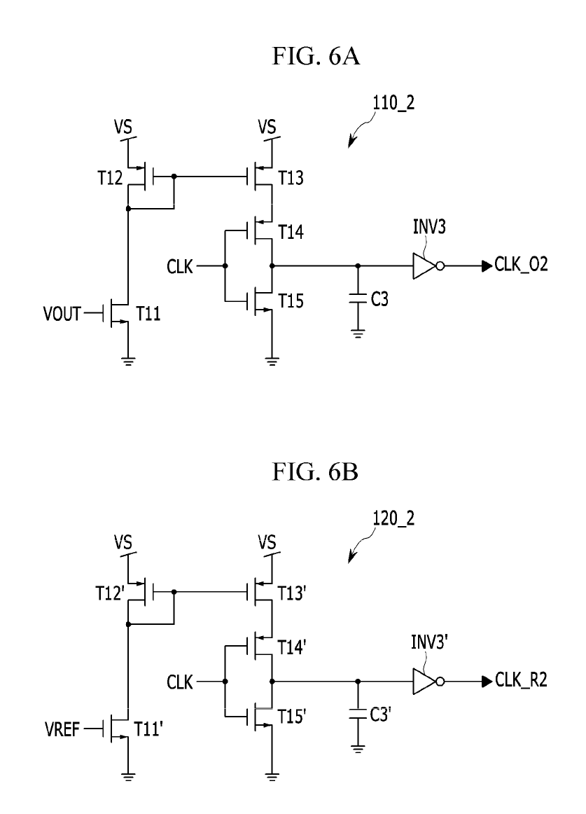

Hereinafter, referring to FIGS. 6A and 6B, a control voltage delay device configured with a first driver and a second driver including a variable current source will be described.

A sampling time of the control voltage delay device including the variable current source is a falling edge time of the reference clock signal.

Accordingly, the D flip-flop 310 shown in FIG. 1 determines an output according to a logical level of an input signal input to the input terminal D at a falling edge time of an input signal input to the clock terminal CK and outputs the output through an output terminal Q.

FIG. 6A shows a circuit diagram of another exemplary variation of the first driver according to an exemplary embodiment of the present invention.

FIG. 6B shows a circuit diagram of another exemplary variation of the second driver according to an exemplary embodiment of the present invention.

As shown in FIGS. 6A and 6B, the first driver 110_2 includes a variable current source generating a source current according to the output voltage VOUT, and the second driver 120_2 includes a variable sink current source generating a source current according to the reference voltage VREF.

The first driver 110_2 includes five transistors T11-T15, a capacitor C3, and an output inverter INV3.

The transistor T11, transistor T12, and the transistor T13 form a variable current source generating a source current according to the output voltage VOUT.

The transistor T11 is an N channel transistor, and the output voltage VOUT is connected to a gate electrode of the transistor T11.

Accordingly, a current flowing through the transistor T11 has a positive characteristic according to the output voltage VOUT.

The transistor T12 and the transistor T13 form a current mirror circuit.

The transistor T12 includes a source electrode connected to a voltage VS, a gate electrode connected to a gate electrode of the transistor T13, and a drain electrode connected to a drain electrode of the transistor T11.

Additionally, the drain electrode and the source electrode of the transistor T12 are connected with each other.

A source electrode of the transistor T13 is connected to the voltage VS, and a current flowing through the transistor T13 is copied and flows through the transistor T14.

Since a current flowing through the transistor T11 flows through the transistor T12, a current having a positive characteristic according to the output voltage VOUT is copied and flows through the transistor T13.

As described above, the variable current source is configured.

The clock signal CLK is input to gate electrodes of the transistor T14, the transistor T15, the transistor T14, and the transistor T15 that configure an inverter. A source electrode of the transistor T14 is connected to a drain electrode of the transistor T13 and a drain electrode of the transistor T14 is connected to a drain electrode of the transistor T15.

Since the transistor T14 is a P channel transistor, the transistor T14 is turned on by a low level clock signal CLK, and since the transistor T15 is an N channel transistor, the transistor T15 is turned on by the high level clock signal CLK.

The capacitor C3 is connected to a node connected with the drain electrode of the transistor T14 and the drain electrode of the transistor T15.

Accordingly, during the turn-on of the transistor T14, the capacitor C3 is charged by the current flowing through the transistor T13, and during the turn-on of the transistor T15, the capacitor C3 is grounded by a current flowing through the transistor 15.

The output inverter INV3 receives and inverts a voltage of the capacitor C3, and outputs it as the output clock signal CLK_O2.

By a charge of the capacitor C3, it takes a period for an output phase of the output inverter INV3 to be inverted.

Accordingly, there is a delay between the clock signal CLK and the output clock signal CLK_O2.

In the same way, there is a delay between the clock signal CLK and the reference clock signal CLK_R2.

In the control voltage delay device 100, including the first driver 110_2 and the second driver 120_2 shown in FIGS. 6A and 6B, an output delay and a reference delay occur in synchronization with a falling edge of the clock signal CLK, and a reference delay and an output delay do not occur at a rising edge of the clock signal CLK.

The transistors T15 and T15′ are turned on at the rising edge of the clock signal CLK, the output inverters INV3 and INV3′ receive a grounded voltage, and the reference clock signal CLK_R2 and output clock signal CLK_O2 are rising to be high level.

According to an exemplary embodiment of the present invention, the control voltage delay device 100 generates the output clock signal CLK_O2 having an output delay from the falling edge time of the clock signal CLK and the reference clock signal CLK_R2 having a reference delay from the falling edge time of the clock signal CLK.

Accordingly, the control voltage delay device 100 can transfer a voltage difference of the output voltage VOUT and the reference voltage VREF to a phase difference of the falling edges of the output clock signal CLK_O2 and the reference clock signal CLK_R2.

That is, if the output voltage VOUT is larger than the reference voltage VREF, a current flowing through the transistor T11 of the first driver 110_2 is larger than a current flowing through the transistor T11′ of the second driver 120_2.

Accordingly, the output delay is shorter than the reference delay.

That it, the falling edge of the output clock signal CLK_O2 is ahead of the falling edge of the reference clock signal CLK_R2.

Alternatively, if the output voltage VOUT is smaller than the reference voltage VREF, a current flowing through the transistor T11 of the first driver 110_2 is smaller than a current flowing through the transistor T11′ of the second driver 120_2.

Accordingly, the output delay is longer than the reference delay.

That is, the falling edge of the output clock signal CLK_O2 lags behind the falling edge of the reference clock signal CLK_R2.

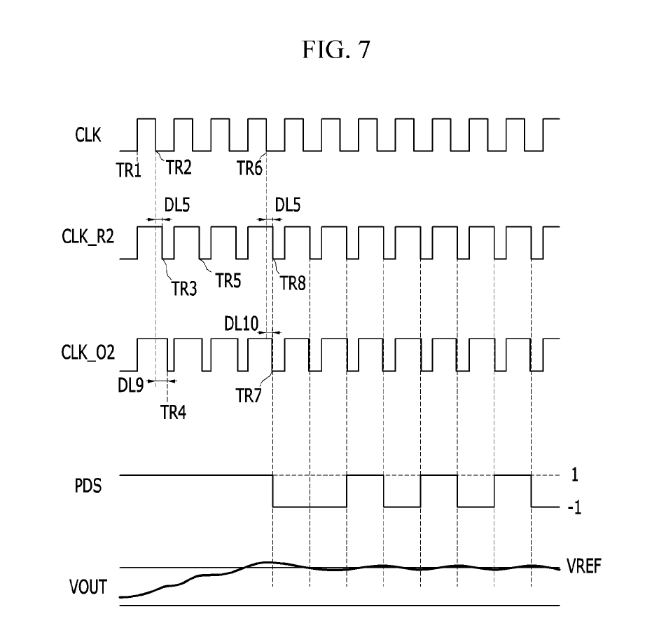

FIG. 7 shows a waveform of a clock signal, an output clock signal, a reference clock signal, a phase detection signal, and an output voltage of a control voltage delay device embodied in the first driver and the second driver of FIGS. 6A and 6B.

FIG. 7 shows a waveform of a predetermined period including a period in which an output voltage is increased and stabilized to a reference voltage.

First, at a time TR1, when the clock signal CLK is rising, the transistors T15 and T15′ are turned on, and a ground voltage is input to the output inverter INV3 and the output inverter INV3′.

The output inverter INV3 inverts the ground voltage to output a high level voltage, so the output clock signal CLK_O2 and the reference clock signal CLK_R2 are rising.

At a time TR2, when the clock signal CLK is falling, the transistor T14 is turned on and the capacitor C3 is charged by the source current corresponding to the output voltage VOUT.

At the time TR2, since the output voltage VOUT is smaller than the reference voltage VREF, the source current of the second driver 120_2 is larger than the source current of the first driver 110_2.

Accordingly, the capacitor C3′ of the second driver 120_2 is more rapidly charged than the capacitor C3 of the first driver 110_2 and at a falling time TR3 of the reference clock signal CLK_R2 is ahead of a falling time TR4 of the output clock signal CLK_O2.

That is, a reference delay DL5 is shorter than an output delay DL9.

The output clock signal CLK_O2 is a high level at the falling edge time point TR3 of the reference clock signal CLK_R2, so the output of the D flip-flop 310 is a high level and the transforming unit 320 generates 1 as the phase detection signal PDS.

The output clock signal CLK_O2 is a high level at the falling edge time point TR5 of the reference clock signal CLK_R2, so the output of the D flip-flop 310 is a high level and the transforming unit 320 generates 1 as the phase detection signal PDS.

At a falling edge time TR6 of the clock signal CLK, the output voltage VOUT is higher than the reference voltage VREF.

Accordingly, the source current of the first driver 110_2 is larger than the source current of the second driver 120_2, and a falling edge time TR7 of the output clock signal CLK_O2 is ahead of a falling edge time TM8 of the reference clock signal CLK_R2.

At this time, an output delay DL10 is shorter than the reference delay DL5.

The output clock signal CLK_O2 is a low level at the falling edge time TR8 of the reference clock signal CLK_R2, so the output of the D flip-flop 310 is a low level and the transforming unit 320 generates −1 as the phase detection signal PDS.

As described above, at the falling edge of the clock signal CLK, according to a voltage difference of the output voltage VOUT and the reference voltage VREF, a phase difference of the output clock signal CLK_O2 and the reference clock signal CLK_R2 occurs.

When the phase detection signal PDS is −1, the digital filter 400 decreases the digital pulse width control signal DPWS[n:0], and when the phase detection signal PDS is 1, the digital filter 400 increases the digital pulse width control signal DPWS[n:0].

The DPWM 600, connected to the control voltage delay device 100 including the first driver 110_2 and the second driver 120_2, increases a duty by the digital pulse width control signal DPWS[n:0] from a minimum duty.

Accordingly, the more the digital pulse width control signal DPWS[n:0] is increased, the more the duty is increased.

During a period in which the output voltage VOUT is increasing to the reference voltage VREF, the phase detection signal PDS is 1 and the duty is increased.

Further, after the output voltage VOUT reaches the reference voltage VREF, the phase detection signal PDS alternately has 1 and −1, and then the duty is maintained with a constant range.

As shown in FIG. 7, the phase detection signal PDS is determined according to the level of the output clock signal CLK_O2 at the falling edge time of the reference clock signal CLK_R2.

A sampling time of the output clock signal according to the exemplary embodiment can be a rising edge time of the reference clock signal as shown in FIG. 3 and FIG. 5, or can be a falling edge time of the reference clock signal as shown in FIG. 7.

According to an exemplary embodiment of the present invention, the control voltage delay device 100 can use a negative characteristic variable current source instead of a positive characteristic variable current source.

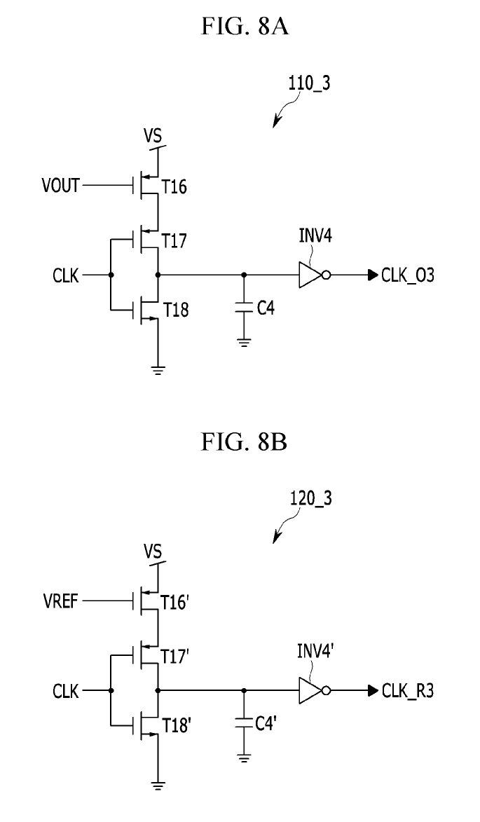

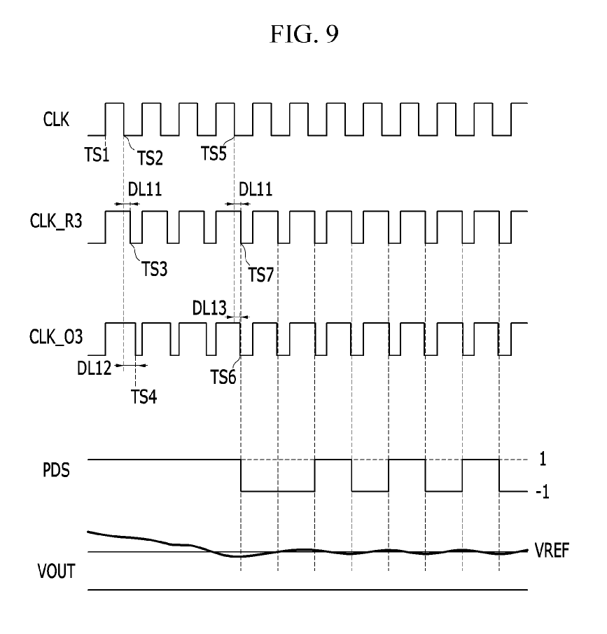

Next, referring to FIGS. 8A, 8B, and 9, a first driver including a variable current source according to a negative characteristic will be described.

A sampling time of the control voltage delay device 100 including a variable current source according to a negative characteristic is a falling edge time of a reference clock signal.

Accordingly, the D flip-flop 310 shown in FIG. 1 determines an output according to a logical level of an input signal input to the input terminal (D) at a falling edge time of an input signal input to the clock terminal (CK), and outputs an output through an output terminal Q.

FIG. 8A shows a circuit diagram of the first driver according to the other exemplary embodiment of the present invention.

FIG. 8B shows a circuit diagram of a second driver according to other exemplary embodiment of the present invention.

As shown in FIG. 8A, the first driver 110_3 includes a variable current source generating a source current according to the output voltage VOUT.

As shown in FIG. 8A, the first driver 110_3 includes three transistors T16-T18, a capacitor C4, and an output inverter INV4.

The same drawing references are used for the same components as the above-described capacitor and output inverter of FIG. 2.

The transistor T16 is a variable current source generating a source current according to the output voltage VOUT.

The output voltage VOUT is input to a gate electrode of the transistor T16.

A drain electrode of the transistor T16 is connected to a source electrode of the transistor T17, and a source electrode of the transistor T16 is connected to a voltage VS.

The clock signal CLK is input to gate electrodes of the transistor T17 and transistor T18. A drain electrode of the transistor T17 is connected to a drain electrode of the transistor T18, and a source electrode of the transistor T18 is grounded. The transistor T17 and the transistor T18 configure an inverter.

The transistors T16 and T17 are P channel transistors, and the transistor T18 is an N channel transistor.

Accordingly, a current flowing through the transistor T16 has a negative characteristic according to the output voltage VOUT.

The capacitor C4 is connected to the drain electrode of the transistor T17 and the drain electrode of the transistor T18.

Accordingly, during the turn-on of the transistor T17, the capacitor C4 is charged by the current flowing through the transistor T16, and during the turn-on of the transistor T18, a ground voltage is applied to the capacitor C4 through the transistor 18.

The output inverter INV4 receives and inverts a voltage of the capacitor C4, and outputs the inverted voltage as the output clock signal CLK_O3.

It takes a period for an output phase of the output inverter INV4 to be inverted by a charge of the capacitor C4.

Accordingly, there is a delay between a falling edge time of the clock signal CLK and a falling edge time of the output clock signal CLK_O3.

In the same way, there is a delay between a falling edge time of the clock signal CLK and a falling edge time of the reference clock signal CLK_R3 of the second driver 120_3 shown in FIG. 8B.

The control voltage delay device 100, including the first driver 110_3 and the second driver 120_3, generates the reference clock signal CLK_R3 having a reference delay and the output clock signal CLK_O3 having an output delay in synchronization with the falling edge of the clock signal CLK.

At a rising edge of the clock signal CLK, there is no delay between a rising edge of the output clock signal CLK_O3 and the rising edge of the clock signal CLK and between a rising edge of the reference clock signal CLK_R3 and the rising edge of the clock signal CLK.

At the rising edge of the clock signal CLK, the transistors T18 and T18′ are turned on, the ground voltage is directly input to the output inverters INV4 and INV4′, and the reference clock signal CLK_R3 and the output clock signal CLK_O3 are rising at the rising edge time of the clock signal CLK.

As above, according to an exemplary embodiment of the present invention, the control voltage delay device 100 generates the output clock signal CLK_O3 having the output delay corresponding to the output voltage VOUT from the falling edge time of the clock signal CLK and the reference clock signal CLK_R3 having the reference delay corresponding to the reference voltage VREF from the falling edge time of the clock signal CLK.

Accordingly, the control voltage delay device 100 can transform a voltage difference of the output voltage VOUT and the reference voltage VREF to a phase difference of the falling edges of the output clock signal CLK_O3 and the reference clock signal CLK_R3.

That is, if the output voltage VOUT is larger than the reference voltage VREF, the current flowing through the transistor T16 of the first driver 110_3 is smaller than the current flowing through the transistor T16′ of the second driver 120_3.

Accordingly, the capacitor C4 of the first driver 110_3 is charged more slowly than a capacitor C4′ of the second driver 120_3, and the output clock signal CLK_O3 falls later than the reference clock signal CLK_R3.

That it, the falling edge of the output clock signal CLK_O3 lags behind the falling edge of the reference clock signal CLK_R3.

Alternatively, if the output voltage VOUT is smaller than the reference voltage VREF, the current flowing through the transistor T16 of the first driver 110_3 is larger than the current flowing through the transistor T16′ of the second driver 120_3.

Accordingly, the capacitor C4 of the first driver 110_3 is charged more rapidly than the capacitor C4′ of the second driver 120_3, and the output clock signal CLK_O3 falls earlier than the reference clock signal CLK_R3.

That is, the falling edge of the output clock signal CLK_O3 is ahead of the falling edge of the reference clock signal CLK_R3.

FIG. 9 shows a waveform of a clock signal, an output clock signal, a reference clock signal, a phase detection signal, and an output voltage of a control voltage delay device embodied in the first driver and the second driver of FIGS. 8A and 8B.

FIG. 9 shows a waveform of a period including a period in which an output voltage is decreased and stabilized to a reference voltage.

When the clock signal CLK is rising at a time TS1, the transistors T18 and 18′ are turned on and the output clock signal CLK_O3 and the reference clock signal CLK_R3 are rising.

When the clock signal CLK is falling at a time TS2, the capacitor C4 is charged by the source current corresponding to the output voltage VOUT.

At the time TS2, since the output voltage VOUT is smaller than the reference voltage VREF, the source current of the second driver 120_3 is larger than the source current of the first driver 110_3.

Accordingly, the capacitor C4′ of the second driver 120_3 is more rapidly charged than the capacitor C4 of the first driver 110_3, and at a falling time TS3 of the reference clock signal CLK_R3 is ahead of a falling time TS4 of the output clock signal CLK_O3.

That is, a reference delay DL11 is shorter than an output delay DL12.

Since the output clock signal CLK_O3 is a high level at the falling edge time point TS3 of the reference clock signal CLK_R3, the output of the D flip-flop 310 is a high level. The transforming unit 320 generates 1 as the phase detection signal PDS.

During a period in which the output voltage VOUT is larger than the reference voltage VREF, the falling edge of the output clock signal CLK_O3 lags behind the falling edge of the reference clock signal CLK_R3 and the phase detection signal PDS is maintained as 1.

At a falling edge time TS5 of the clock signal CLK, the output voltage VOUT is lower than the reference voltage VREF.

Accordingly, the source current of the first driver 110_3 is larger than the source current of the second driver 120_3, and a falling edge time TS6 of the output clock signal CLK_O3 is ahead of a falling edge time TS7 of the reference clock signal CLK_R3.

An output delay DL13 is shorter than the reference delay DL11.

Since the output clock signal CLK_O3 is a low level at the falling edge time TS7 of the reference clock signal CLK_R3, the output of the D flip-flop 310 is a low level. The transforming unit 320 generates −1 as the phase detection signal PDS.

As described above, according to a voltage difference of the output voltage VOUT and the reference voltage VREF at the falling edge of the clock signal CLK, a phase difference of the output clock signal CLK_O3 and the reference clock signal CLK_R3 occurs.

According to the level of the output clock signal CLK_O3 at the falling edge time of the reference clock signal CLK_R3, the phase detection signal PDS is determined.

When the phase detection signal PDS is −1, the digital filter 400 decreases the digital pulse width control signal DPWS[n:0], and when the phase detection signal PDS is 1, the digital filter 400 increases the digital pulse width control signal DPWS[n:0].

According to the control voltage delay device 100 configured with the first driver 110_3 and the second driver 120_3, the DPWM 600 decrease a duty by the digital pulse width control signal DPWS[n:0] from a maximum duty.

Accordingly, the more the digital pulse width control signal DPWS[n:0] is increased, the more the duty is decreased.

That is, the phase detection signal PDS is 1 during a period in which the output voltage VOUT is decreased to the reference voltage VREF, so the duty is decreased.

Also, after the output voltage VOUT reaches the reference voltage VREF, the phase detection signal PDS alternately has 1 and −1, so the duty is maintained with a constant range.

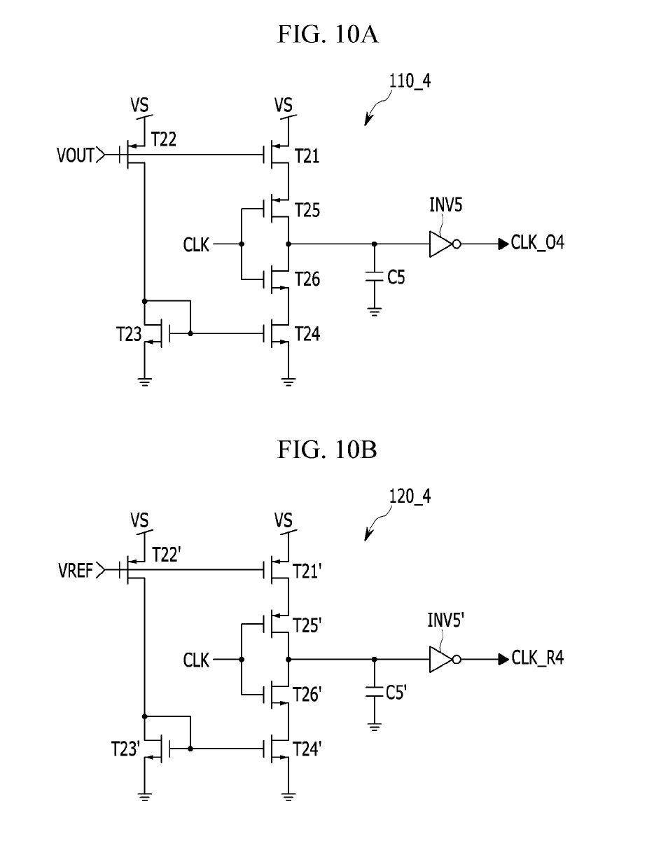

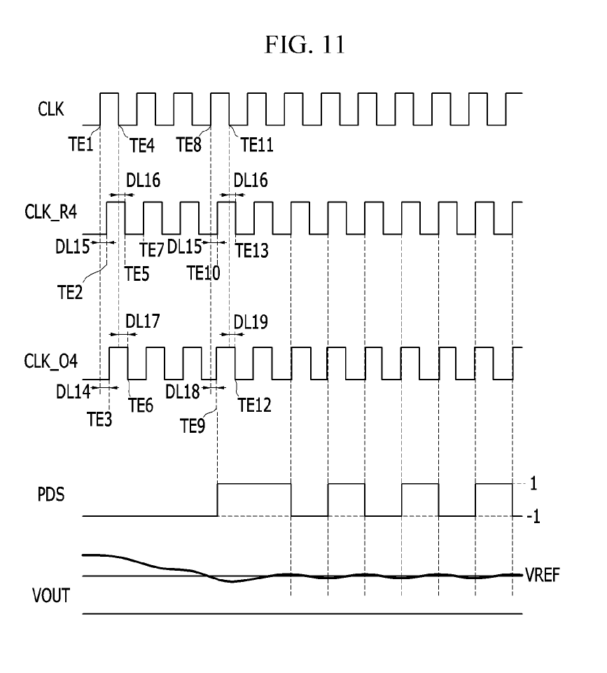

Hereinafter, referring to FIGS. 10A, 10b and 11, a control voltage delay device configured with a first driver and a second driver including a variable current source according to a negative characteristic and a variable sink current source according to a negative characteristic will be described.

FIG. 10A shows a circuit diagram of an exemplary variation of the first driver according to the other exemplary embodiment of the present invention.

FIG. 10B shows a circuit diagram of an exemplary variation of the second driver according to the other exemplary embodiment of the present invention.

The control voltage delay device 100 including the first driver 110_4 and the second driver 120_4 generates a reference clock signal CLK_R4 and an output clock signal CLK_O4 having a delay in synchronization with a rising edge and a falling edge of the clock signal CLK.

The first driver 110_4 includes six transistors T21-T26, a capacitor C5, and an output inverter INV5.

The transistor T21 is a variable current source generating a source current according to the output voltage VOUT.

The transistor T22, the transistor T23, and the transistor T24 form a variable sink current source generating a sink current according to the output voltage VOUT.

The transistor T21 and the transistor T22 are P channel transistors, and the output voltage VOUT is connected with gate electrodes of the transistor T21 and transistor T22.

Accordingly, a current flowing through the transistor T21 and transistor T22 has a negative characteristic according to the output voltage VOUT.

The transistor T23 and the transistor T24 form a current mirror circuit.

The transistor T23 includes a source electrode connected to ground, a gate electrode connected to a gate electrode of the transistor T24, and a drain electrode connected to a drain electrode of the transistor T22.

Additionally, the drain electrode and the gate electrode of the transistor T23 are connected with each other.

A source electrode of the transistor T24 is connected to the ground, and a current flowing through the transistor T23 is copied and flows through the transistor T24.

A current flowing through the transistor T22 that has a negative characteristic according to the output voltage VOUT flows through the transistor T23, and the current flowing through the transistor T23 is copied and flows through the transistor T24. Therefore, the sink current flowing through the transistor T24 has a negative characteristic according to the output voltage VOUT.

As described above, the variable sink current source is configured.

The clock signal CLK is input to gate electrodes of the transistor T25 and the transistor T26, and the transistor T25 and transistor T26 configure an inverter. A source electrode of the transistor T25 is connected to a drain electrode of the transistor T21, and a source electrode of the transistor T26 is connected to a drain electrode of transistor T24.

Since the transistor T25 is a P channel transistor, the transistor T25 is turned on by a low level clock signal CLK, and since the transistor T26 is an N channel transistor, the transistor T26 is turned on by the high level clock signal CLK.

The capacitor C5 is connected to the drain electrode of the transistor T25 and the drain electrode of the transistor T26.

Accordingly, during the turn-on of the transistor T25, the capacitor C5 is charged by the current flowing through the transistor T21, and during the turn-on of the transistor T26, the capacitor C5 is discharged by a current flowing through the transistor 24.

An output inverter INV5 receives and inverts a voltage of the capacitor C5, and outputs the inverted voltage as the output clock signal CLK_O4.

It takes a period for an output phase of the output inverter INV5 to be inverted by a charge or a discharge of the capacitor C5.

Accordingly, there is a delay between the clock signal CLK and the output clock signal CLK_O4.

For the same reason, there is a delay between the clock signal CLK and the reference clock signal CLK_R4.

An output delay between the clock signal CLK and the output clock signal CLK_O4 and a reference delay between the clock signal CLK and the reference clock signal CLK_R4 occur at a rising edge time point and a falling edge time point.

The control voltage delay device 100 differently generates the output delay and the reference delay according to the voltage difference of the output voltage VOUT and the reference voltage VREF, and transforms a voltage difference of the output voltage VOUT and the reference voltage VREF to a phase difference of the output clock signal CLK_O4 and the reference clock signal CLK_R4.

That is, if the output voltage VOUT is smaller than the reference voltage VREF, currents respectively flowing through the transistor T21 and the transistor T22 of the first driver 110_4 are larger than currents respectively flowing through a transistor T21′ and a transistor T22′ of the second driver 120_4.

Accordingly, the output delay is shorter than the reference delay, and a phase of the output clock signal CLK_O4 is ahead of a phase of the reference clock signal CLK_R4.

Alternatively, if the output voltage VOUT is larger than the reference voltage VREF, currents respectively flowing through the transistor T21 and the transistor T22 of the first driver 110_4 are smaller than currents respectively flowing through the transistor T21′ and the transistor T22′ of the second driver 120_4.

Accordingly, the output delay is longer than the reference delay, and a phase of the output clock signal CLK_O4 lags behind a phase of the reference clock signal CLK_R4.

FIG. 11 shows a waveform of a clock signal, an output clock signal, a reference clock signal, a phase detection signal, and an output voltage of a control voltage delay device embodied in the first driver and the second driver of FIGS. 10A and 10B.

FIG. 11 shows a waveform of a period including a period in which an output voltage VOUT is increased and stabilized to a reference voltage.

The clock signal CLK is rising at a time TE1, and the transistor T26 is turned on at the time TE1. The capacitor C5 is discharged by a sink current corresponding to the output voltage VOUT.

At the time TE1, since the output voltage VOUT is larger than the reference voltage VREF, the sink current of the second driver 120_4 is larger than the sink current of the first driver 110_4.

Accordingly, the capacitor C5′ of the second driver 120_4 is discharged more rapidly than the capacitor C5 of the first driver 110_4, and a rising time TE2 of the reference clock signal CLK_R4 is ahead of a rising time TE3 of the output clock signal CLK_O4.

That is, a reference delay DL15 is shorter than an output delay DL14.

The clock signal CLK is falling at a time TE4, and the transistor T25 is turned on at the time TE4. The capacitor C5 is charged by the source current corresponding to the output voltage VOUT.

At the time TE4, since the output voltage VOUT is larger than the reference voltage VREF, the source current of the second driver 120_4 is larger than the source current of the first driver 110_4.

Accordingly, the capacitor C5′ of the second driver 120_4 is more rapidly charged than the capacitor C5 of the first driver 110_4, and a falling time TE5 of the reference clock signal CLK_R4 is ahead of a falling time TE6 of the output clock signal CLK_O4.

That is, a reference delay DL16 is shorter than an output delay DL17.

The reference delay DL15 between a rising edge of the clock signal CLK and a rising edge of the reference clock signal CLK_R4 is constant, and the reference delay DL16 between a falling edge of the clock signal CLK and a falling edge of the reference clock signal CLK_R4 is constant.

The reference delay DL15 can be same as the reference delay DL16.

At the rising edge time TE2 of the reference clock signal CLK_R4, the output clock signal CLK_O4 is a low level and the output of the D flip-flop 310 is a low level, and the transforming unit 320 generates −1 as the phase detection signal PDS.

At a rising edge time TE7 of the reference clock signal CLK_R4, the output clock signal CLK_O1 is a low level and the output of the D flip-flop 310 is a low level, and the transforming unit 320 generates −1 as the phase detection signal PDS.

At a rising edge time TE8 of the clock signal CLK, the output voltage VOUT is lower than the reference voltage VREF.

Accordingly, the sink current of the first driver 110_4 is larger than the sink current of the second driver 120_4, and a rising edge time TE9 of the output clock signal CLK_O4 is ahead of a rising edge time TE10 of the reference clock signal CLK_R4.

At this time, an output delay DL17 is shorter than the reference delay DL11.

At the rising edge time TE10 of the reference clock signal CLK_R4, the output clock signal CLK_O4 is a high level and the output of the D flip-flop 310 is a high level, and the transforming unit 320 generates 1 as the phase detection signal PDS.

At a falling edge time TE11 of the clock signal CLK, the output voltage VOUT is lower than the reference voltage VREF.

Accordingly, the source current of the first driver 110_4 is larger than the source current of the second driver 120_4, and a falling edge time TE12 of the output clock signal CLK_O4 is ahead of a falling edge time TE13 of the reference clock signal CLK_R4.

At this time, an output delay DL18 is shorter than the reference delay DL15.

As described above, according to a voltage difference of the output voltage VOUT and the reference voltage VREF at the rising edge time and the falling edge time of the clock signal CLK, a phase difference of the output clock signal CLK_O4 and the reference clock signal CLK_R4 occurs.

When the phase detection signal PDS is −1, the digital filter 400 decreases the digital pulse width control signal DPWS[n:0], and when the phase detection signal PDS is 1, the digital filter 400 increases the digital pulse width control signal DPWS[n:0].

The DPWM 600, connected to the control voltage delay device 100 including the first driver 110_4 and the second driver 120_4, increases a duty by the digital pulse width control signal DPWS[n:0] from a minimum duty.

Accordingly, the more the digital pulse width control signal DPWS[n:0] is decreased, the more the duty is decreased.

During a period in which the output voltage VOUT is decreased to the reference voltage VREF, the phase detection signal PDS is −1, so the duty is decreased.

Also, after the output voltage VOUT reaches the reference voltage VREF, the phase detection signal PDS alternately has 1 and −1, so the duty is maintained with a constant range.

FIG. 11 shows a waveform with which the phase detection signal PDS is determined according to a level of the output clock signal CLK_O4 at the rising edge time of reference clock signal CLK_R4, but the present invention is not limited thereto.

That is, as a waveform shown in FIG. 9, a sampling time of the output clock signal can change a falling edge time of the reference clock signal, not a rising edge time of the reference clock signal.

In more detail, the phase detection signal PDS is determined according to a level of the output clock signal CLK_O4 at a falling edge time of the reference clock signal CLK_R4, and the phase detection signal PDS can have a phase contrary to that of the waveform shown in FIG. 11.

Then, the DPWM 600 may be designed to decrease a duty by the digital pulse width control signal DPWS[n:0] from maximum duty.

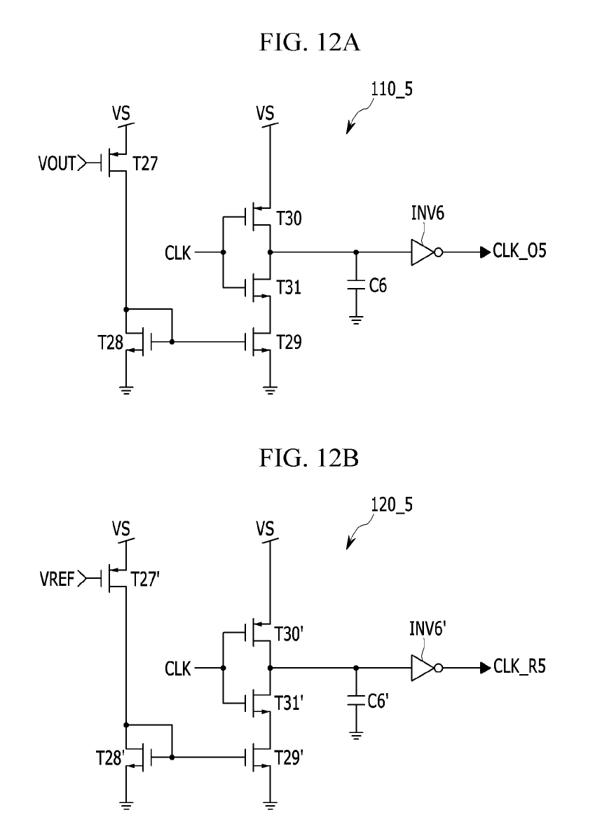

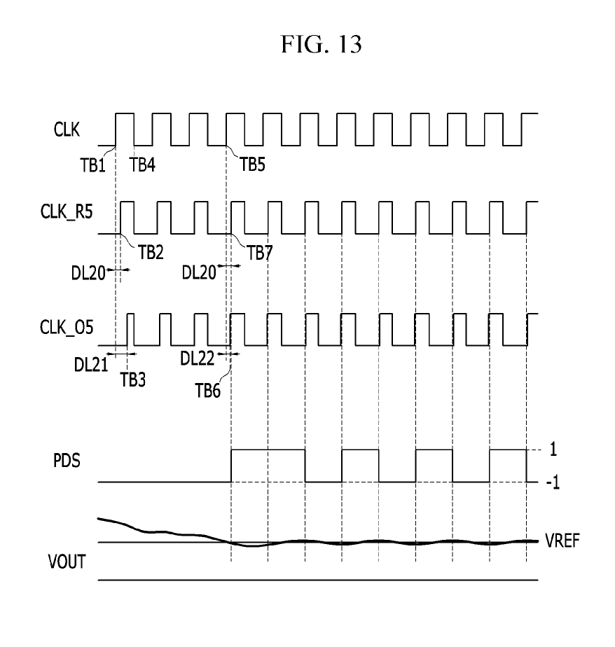

Hereinafter, referring to FIGS. 12A, 12B, and FIG. 13, a control voltage delay device configured with a first driver and a second driver including a variable sink current source having a negative characteristic will be described.

FIG. 12A shows a circuit diagram of another exemplary variation of the first driver according to the other exemplary embodiment of the present invention.

FIG. 12B shows a circuit diagram of another exemplary variation of the first driver according to the other exemplary embodiment of the present invention.

As shown in FIG. 12A, the first driver 110_5 includes a variable sink current source generating a sink current according to the output voltage VOUT.

The first driver 110_5 includes five transistors T27-T31, a capacitor C6, and an output inverter INV6.

The transistor T27, transistor T28, and the transistor T29 form a variable sink current source generating a sink current according to the output voltage VOUT.

The transistor T27 is a P channel transistor, and the output voltage VOUT is connected to a gate electrode of the transistor T27.

Accordingly, a current flowing through the transistor T27 has a negative characteristic according to the output voltage VOUT.

The transistor T28 and the transistor T29 form a current mirror circuit.

The transistor T28 includes a source electrode connected to ground, a gate electrode connected to a gate electrode of the transistor T29, and a drain electrode connected to a drain electrode of the transistor T27.

Additionally, the drain electrode and the gate electrode of the transistor T28 are connected with each other.

A source electrode of the transistor T29 is connected to the ground, and a current flowing through the transistor T28 is copied and flows through the transistor T29.

A current flowing through the transistor T27 that has a negative characteristic according to the output voltage VOUT flows through the transistor T28, and the current flowing through the transistor T28 is copied and flows through the transistor T29. Therefore, the sink current flowing through the transistor T29 has a negative characteristic according to the output voltage VOUT.

As described above, the variable sink current source is configured.

The clock signal CLK is input to gate electrodes of the transistor T30 and the transistor T31, and the transistor T30 and transistor T31 configure an inverter. A source electrode of the transistor T31 is connected to a drain electrode of the transistor T29, and a source electrode of the transistor T30 is connected to a voltage VS.

Since the transistor T30 is a P channel transistor, the transistor T30 is turned on by a low level clock signal CLK, and since the transistor T31 is an N channel transistor, the transistor T31 is turned on by the high level clock signal CLK.

The capacitor C6 is connected to the drain electrode of the transistor T30 and the drain electrode of the transistor T31.

Accordingly, during the turn-on of the transistor T31, the capacitor C6 is discharged by the current flowing through the transistor T29, and during the turn-on of the transistor T30, the capacitor C6 is connected to the voltage VS.

An output inverter INV6 receives and inverts a voltage of the capacitor C6, and outputs the inverted voltage as the output clock signal CLK_O5.

It takes a period for an output phase of the output inverter INV6 to be inverted by a discharge of the capacitor C6.

Accordingly, there is a delay between the clock signal CLK and the output clock signal CLK_5.

At the falling edge of the clock signal CLK, the transistor T30 and a transistor T30′ are turned on, the output inverters INV6 and INV6′ receive the voltage VS, and the reference clock signal CLK_R5 and output clock signal CLK_O5 are falling.

As stated above, the control voltage delay device 100 generates the output clock signal CLK_O5 having an output delay at the rising edge time of the clock signal CLK and the reference clock signal CLK_R5 having a reference delay at the rising edge time of the clock signal CLK.

Accordingly, the control voltage delay device 100 can transform a voltage difference of the output voltage VOUT and the reference voltage VREF to a phase difference of the rising edges of the output clock signal CLK_O5 and the reference clock signal CLK_R5.

That is, if the output voltage VOUT is smaller than the reference voltage VREF, a current flowing through the transistor T27 of the first driver 110_5 is larger than a current flowing through a transistor T27′ of the second driver 120_5.

Accordingly, the output delay is shorter than the reference delay, and the rising edge of the output clock signal CLK_O5 is ahead of the falling edge of the reference clock signal CLK_R5.

Alternatively, if the output voltage VOUT is larger than the reference voltage VREF, a current flowing through the transistor T27 of the first driver 110_5 is smaller than a current flowing through the transistor T27′ of the second driver 120_5.

Accordingly, the output delay is longer than the reference delay, and the rising edge of the output clock signal CLK_O5 lags behind the rising edge of the reference clock signal CLK_R5.

FIG. 13 shows a waveform of a clock signal, an output clock signal, a reference clock signal, a phase detection signal, and an output voltage of a control voltage delay device embodied in the first driver and the second driver of FIGS. 12A and 12B.

FIG. 13 shows a waveform of a period including a period in which an output voltage is decreased and stabilized to a reference voltage

The clock signal CLK is rising at a time point TB1 and the transistor T31 is turned on. The capacitor C6 is discharged by a sink current corresponding to the output voltage VOUT.

Since the output voltage VOUT is larger than the reference voltage VREF at the time point TB1, the sink current of the second driver 120_5 is larger than the sink current of the first driver 110_5.

Accordingly, the capacitor C6′ of the second driver 120_5 is discharged more rapidly than the capacitor C6 of the first driver 110_5, and a rising time point TB2 of the reference clock signal CLK_R5 is ahead of a rising time point TB3 of the output clock signal CLK_O5.

That is, a reference delay DL20 is shorter than an output delay DL21.

At the rising edge time point TB2 of the reference clock signal CLK_R5, the output clock signal CLK_O5 is a low level. So, the output of the D flip-flop 310 is a low level and the transforming unit 320 generates −1 as the phase detection signal PDS.

The clock signal CLK is falling at a time point TB4 and the transistors T30 and T30′ are turned on, and the output clock signal CLK_O5 and the reference clock signal CLK_R5 are falling.

During a period in which the output voltage VOUT is larger than the reference voltage VREF, the rising edge of the output clock signal CLK_O5 lags behind the rising edge of the reference clock signal CLK_R5 and the phase detection signal PDS is maintained as −1.

At a rising time point TB5 of the clock signal CLK, the output voltage VOUT is lower than the reference voltage VREF.

Accordingly, the sink current of the first driver 110_5 is larger than the sink current of the second driver 120_5, and a rising edge time point TB6 of the output clock signal CLK_O5 is ahead of a rising edge time point TB7 of the reference clock signal CLK_R5.

An output delay DL22 is shorter than the reference delay DL20.

At the rising edge time point TB7 of the reference clock signal CLK_R5, the output clock signal CLK_O5 is a high level and the output of the D flip-flop 310 is a high level, so the transforming unit 320 generates 1 as the phase detection signal PDS.

As described above, a phase difference of the output clock signal CLK_O5 and the reference clock signal CLK_R5 occurs according to a voltage difference of the output voltage VOUT and the reference voltage VREF at the rising edge time point of the clock signal CLK.

The phase detection signal PDS occurs according to a level of the output clock signal CLK_O5 at rising edge time point of the reference clock signal CLK_R5.

When the phase detection signal PDS is −1, the digital filter 400 decreases the digital pulse width control signal DPWS[n:0], and when the phase detection signal PDS is 1, the digital filter 400 increases the digital pulse width control signal DPWS[n:0].

The DPWM 600, connected to the control voltage delay device 100 including the first driver and the second driver shown in FIG. 12, increases a duty by the digital pulse width control signal DPWS[n:0] from a minimum duty.

Accordingly, the more the digital pulse width control signal DPWS[n:0] is decreased, the more the duty is decreased.

During a period in which the output voltage VOUT is decreased to the reference voltage VREF, since the phase detection signal PDS is −1, the duty is decreased.

Also, after the output voltage VOUT reaches the reference voltage VREF, since the phase detection signal PDS alternately has 1 and −1, the duty is maintained with a constant range.

Thus far, various exemplary variations of the first driver and the second driver have been described.

However, the present invention is not limited thereto.

A control voltage delay device can include a first driver and a second driver including a capacitor that is changed according to an output voltage and a reference voltage, instead of a variable sink current source and a variable current source according to an output voltage and the reference voltage.

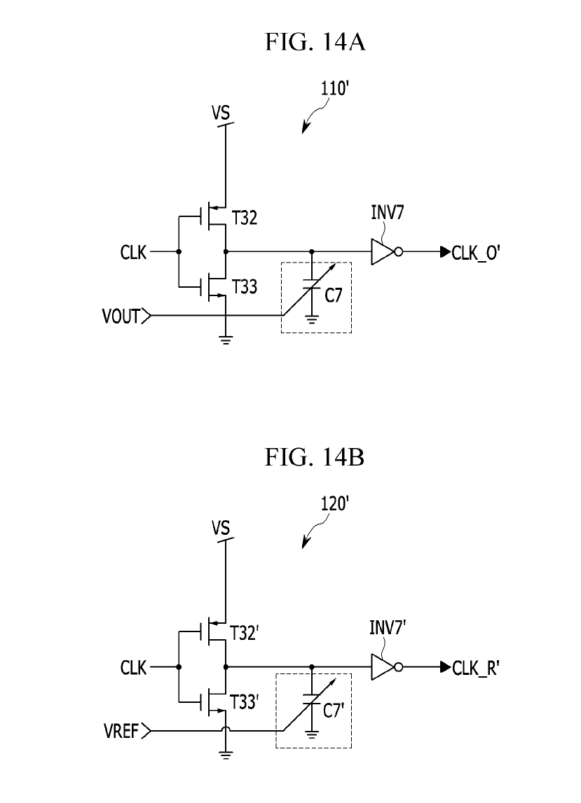

FIG. 14A shows a circuit diagram of an example of a first driver according to another exemplary embodiment of the present invention.

As shown in FIG. 14A, a first driver 110′ includes a capacitor C7 having capacity changed according to the output voltage VOUT.

The first driver 110′ includes a transistor T32, a transistor T33, and an output inverter INV7.

A first terminal of the capacitor C7 is connected to an input terminal of the output inverter INV2, a drain electrode of the transistor T32, and a drain electrode of the transistor T33.

Capacity of the capacitor C7 is determined according to the output voltage VOUT.

When the clock signal CLK is a low level, the transistor T32 is turned on, and the voltage VS and the capacitor C7 are connected.

A charge speed of the capacitor C7 by the Voltage VS is determined according to capacity of the capacitor C7 at this time.

Accordingly, the charge speed is determined according to the output voltage VOUT, and a delay between a falling edge time of the clock signal CLK and a falling edge time of the output clock signal(CLK_O′) occurs.

When the clock signal CLK is a high level, the transistor T33 is turned on and the ground is connected to the capacitor C2.

A discharge speed of the capacitor C2 by the ground is determined according to capacity of the capacitor C2 at this time.

Accordingly, the discharge speed is determined according to the output voltage VOUT and a delay between a rising edge time of the clock signal CLK and a rising edge time of the output clock signal CLK_O′ occurs.

FIG. 14B shows a circuit diagram of a second driver according to another exemplary embodiment of the present invention.

As shown in FIG. 14B, the second driver 120′ includes a capacitor C7′ having capacity that is changed according to the reference voltage VREF.

However, the reference voltage VREF is maintained as a constant voltage in another exemplary embodiment, and the capacity of the capacitor (C7′) is maintained constantly.

When the clock signal CLK is a low level, the transistor T32′ is turned on and the capacitor C7′ is charged by the voltage VS with a predetermined charge speed.

Then, a predetermined delay between a falling edge time of the clock signal CLK and a falling edge time of the output clock signal CLK_R′ occurs according to the capacity determined by the reference voltage VREF.

When the clock signal CLK is a high level, the transistor T33′ is turned on and the capacitor C2′ is discharged by the ground with a predetermined discharge speed.

Then, a predetermined delay between a rising edge time of the clock signal CLK and a rising edge time of the output clock signal CLK_R′ occurs according to the capacity determined by the reference voltage VREF.

Like the above, the output clock signal CLK_O′ having an output delay to the clock signal CLK is generated by using the capacitor C2 having capacity that is determined according to the output voltage VOUT, and the reference clock signal CLK_R′ having a reference delay according to the clock signal CLK is generated by using the capacitor C2′ having capacity that is determined according to the reference voltage VREF.

A plurality of exemplary embodiments that generate an output clock signal having an output delay according to an output voltage and a reference clock signal having a reference delay according to a reference voltage and use a phase difference between the both clock signals to regular the output voltage have been described.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of Symbols>

control voltage delay device 100, digital power converter 200, power switch S

diode D, inductor L, capacitors C, C1-C7, C1′-C7′

digital power converter 200, phase detector 300, digital filter 400

clock generator 500, digital pulse width modulator 600, D flip-flop 310

transforming unit 320, differentiator 410, integrator 420, proportional gain unit 430

differential gain unit 440, integral gain unit 450, adder 460

first driver 110, 110_1, 110_2, 110_3, 110_4, 110_5, 110′

second driver 120, 120_1, 120_2, 120_3, 120_4, 120_5, 120′

transistor T1-T9, T1′-T9′, T11-T18, T11′-T18′, T21-33, T21′-T33′

output inverter INV1-INV7, INV1′-INV7′

What is claimed is:

1. A control voltage delay device generating an output clock signal and a reference clock signal to control an output voltage of a digital power converter, the control voltage delay device comprising:
a first driver generating the output clock signal having an output delay to a clock signal according to the output voltage; and
a second driver generating the reference clock signal having a reference delay to the clock signal according to a reference voltage being a target value of the output voltage.

2. The control voltage delay device of claim 1, wherein
the first driver comprises:
a first transistor including a gate electrode receiving the output voltage and a first terminal connected to a first voltage;
an inverter connected between a second terminal of the first transistor and a second voltage and receiving the clock signal;
a capacitor connected to an output terminal of the inverter; and
an output inverter connected to the capacitor and the output terminal of the inverter,
wherein an output of the output inverter is the output clock signal.

3. The control voltage delay device of claim 2, wherein
the inverter comprises:
a second transistor including a gate electrode where the clock signal is input and a first terminal connected to a second terminal of the first transistor; and
a third transistor including a first terminal connected to a second terminal of the second transistor, a gate electrode receiving the clock signal, and a second terminal connected to the second voltage, and
the output terminal of the inverter is connected to the second transistor and the third transistor.

4. The control voltage delay device of claim 2, wherein
the second driver comprises:
a fourth transistor including a gate electrode where the reference voltage is input and a first terminal connected to the first voltage;
a first inverter connected between a second terminal of the fourth transistor and the second voltage and receiving the clock signal;
a first capacitor connected to an output terminal of the first inverter; and
a first output inverter connected to the first capacitor and the output terminal of the first inverter,
wherein an output of the first output inverter is the reference clock signal.

5. The control voltage delay device of claim 4, wherein
the first transistor and the fourth transistor are N channel transistors, and the second voltage is higher than the first voltage.

6. The control voltage delay device of claim 5, wherein
the output delay is generated when the capacitor of the first driver is discharged by a sink current flowing through the first transistor of the first driver according to the output voltage, and
the reference delay is generated when the first capacitor of the second driver is discharged by a sink current flowing through the fourth transistor of the second driver according to the reference voltage.

7. The control voltage delay device of claim 4, wherein
the first transistor and the fourth transistor are P channel transistors, and the second voltage is lower than the first voltage.

8. The control voltage delay device of claim 7, wherein
the output delay is generated when the capacitor of the first driver is charged by a source current flowing through the first transistor of the first driver according to the output voltage, and
the reference delay is generated when the first capacitor of the second driver is charged by a source current flowing through the fourth transistor of the second driver according to the reference voltage.

9. The control voltage delay device of claim 1, wherein
the first driver comprises:
a fifth transistor including a gate electrode where the output voltage is input and a first terminal connected to a first voltage;
a current mirror circuit connected with a second terminal of the first transistor and the second voltage and mirroring a current flowing through the first transistor;
an inverter outputting an output of the current mirror circuit according to the clock signal;
a capacitor connected to an output terminal of the inverter; and
an output inverter connected to the capacitor and the output terminal of the inverter,
wherein an output terminal of the output inverter is the output clock signal.

10. The control voltage delay device of claim 9, wherein
the current mirror circuit comprises:
a sixth transistor including a first terminal connected to a second terminal of the fifth transistor, a second terminal connected to the second voltage, and a gate electrode connected to the first terminal of the six transistor; and
a seventh transistor including a gate electrode connected to the gate electrode of the sixth transistor, a first terminal connected to the second voltage, and a second terminal connected to the inverter.

11. The control voltage delay device of claim 9, wherein
the inverter comprises:
an eighth transistor including a first terminal connected to the output of the current mirror circuit and a gate electrode where the clock signal is input; and
a ninth transistor including a first terminal connected to the second terminal of the eighth transistor, a second terminal connected to the first voltage, and a gate electrode where the clock signal is input,
wherein the output terminal of the inverter is connected to the eighth transistor and the ninth transistor.

12. The control voltage delay device of claim 9, wherein
the second driver comprises:
a tenth transistor including a gate electrode where the reference voltage is input and a first terminal connected to the first voltage;
a first current mirror circuit connected with a second terminal of the tenth transistor and the second voltage and mirroring a current flowing through the tenth transistor;
a first inverter outputting an output of the first current mirror circuit according to the clock signal;
a first capacitor connected to an output terminal of the first inverter; and
a first output inverter connected to the first capacitor and the output terminal of the first inverter,
wherein an output of the first output inverter is the reference clock signal.

13. The control voltage delay device of claim 12, wherein
the fifth transistor and the tenth transistor are N channel transistors, and the second voltage is higher than the first voltage.

14. The control voltage delay device of claim 13, wherein
the output delay is generated when the capacitor of the first driver is charged by a source current generated by copying a current flowing through the fifth transistor of the first driver according to the output voltage, and
the reference delay is generated when the first capacitor of the second driver is charged by a source current generated by copying a current flowing through the tenth transistor of the second driver according to the reference voltage.

15. The control voltage delay device of claim 12, wherein
the fifth transistor and the tenth transistor are P channel transistors, and the second voltage is lower than the first voltage.

16. The control voltage delay device of claim 15, wherein
the output delay is generated when the capacitor of the first driver is discharged by a sink current generated by copying a current flowing through the fifth transistor of the first driver according to the output voltage, and
the reference delay is generated when the first capacitor of the second driver is discharged by a sink current generated by copying a current flowing through the tenth transistor of the second driver according to the reference voltage.

17. The control voltage delay device of claim 1, wherein
the first driver comprises:
a second capacitor having a capacity that is changed according to the output voltage;
a second inverter including an output terminal connected to the second capacitor and an input terminal where the clock signal is input; and
a second output inverter connected with the output terminal of the second inverter and the second capacitor,
wherein an output of the second output inverter is the output clock signal.

18. The control voltage delay device of claim 17, wherein
the second driver comprises:
a third capacitor having a capacity that is changed according to the reference voltage;
a third inverter including an output terminal connected to the third capacitor and an input terminal where the clock signal is input; and
a third output inverter connected with an output terminal of the third inverter and the third capacitor,
wherein an output of the third output inverter is the reference clock signal.

19. The control voltage delay device of any one of claim 1, wherein
the clock signal is a signal for controlling an operation of the digital power converter.

20. A digital power converter transforming from an input voltage to an output voltage, comprising:
a power switch controlling a transforming operation;
a control voltage delay device generating an output clock signal having an output delay according to an output voltage to a clock signal controlling an operation of the digital power converter and a reference clock signal having a reference delay according to a reference voltage to the clock signal;
a phase detector generating a phase detection signal according to a phase difference between the output clock signal and the reference clock signal; and
a digital filter generating a digital pulse width control signal controlling a duty of the power switch according to the phase detection signal.

21. The digital power converter of claim 20, wherein
the phase detector comprises
a D flip-flop sampling the output clock signal at an edge time of the reference clock signal, and
the phase detection signal is determined according to a result of the sampling.

22. The digital power converter of claim 21, wherein
the digital filter multiplies a differentiated phase detection signal by a differentiation gain to generate a first value, multiplies an integrated phase detection signal by an integration gain to generate a second value, multiplies the phase detection signal by a proportion gain to generate a third value, and sums the first value, the second value, and the third value to generate the digital pulse width control signal, and
the differentiation gain, the integration gain and the proportion gain are set according to a range of the digital pulse width control signal.

23. The digital power converter of claim 20, further comprising
a DPWM (digital pulse width modulator) controlling turn-on of the power switch according to the clock signal and turn-off of the power switch according to the digital pulse width control signal.

24. The digital power converter of claim 20, wherein
the control voltage delay device comprises
a first driver generating the output clock signal and a second driver generating the reference clock signal,
wherein the first driver comprises:
a first transistor including a gate electrode where the output voltage is input and a first terminal connected to a first voltage;
an inverter connected between a second terminal of the first transistor and a second voltage and receiving the clock signal;
a capacitor connected to an output terminal of the inverter; and
an output inverter connected to the capacitor and the output terminal of the inverter, and
wherein the second driver comprises:
a second transistor including a gate electrode where the reference voltage is input and a first terminal connected to the first voltage;
a first inverter connected with a second terminal of the second transistor and the second voltage receiving the clock signal;
a first capacitor connected to an output terminal of the first inverter; and
a first output inverter connected to the first capacitor and the output terminal of the first inverter,
wherein an output of the output inverter is the output clock signal and an output of the first output inverter is the reference clock signal.

25. The digital power converter of claim 24, wherein
the first transistor and the second transistor are N channel transistors, and the second voltage is higher than the first voltage.

26. The digital power converter of claim 25, wherein
the output delay is generated when the capacitor is discharged by a sink current flowing through the first transistor according to the output voltage, and
the reference delay is generated when the first capacitor is discharged by a sink current flowing through the second transistor according to the reference voltage.

27. The digital power converter of claim 24, wherein
the first transistor and the second transistor are P channel transistors, and the second voltage is lower than the first voltage.

28. The digital power converter of claim 27, wherein
the output delay is generated when the capacitor is charged by a source current flowing through the first transistor according to the output voltage, and
the reference delay is generated when the first capacitor is charged by a source current flowing through the second transistor according to the reference voltage.

29. The digital power converter of claim 20, wherein
the control voltage delay device comprises
a first driver generating the output clock signal and a second driver generating the reference clock signal,
wherein the first driver comprises:
a third transistor including a gate electrode where the output voltage is input and a first terminal connected to a first voltage;
a current mirror circuit connected with a second terminal of the third transistor and a second voltage and mirroring a current flowing through the third transistor;
an inverter outputting an output of the current mirror circuit according to the clock signal;
a capacitor connected to an output terminal of the inverter; and
an output inverter connected to the capacitor and the output terminal of the inverter, and
wherein the second driver comprises:
a fourth transistor including a gate electrode receiving the reference voltage and a first terminal connected to the first voltage;
a first current mirror circuit connected with a second terminal of the fourth transistor and the second voltage and mirroring a current flowing through the fourth transistor;
a first inverter outputting an output of the first current mirror circuit according to the clock signal;
a first capacitor connected to an output terminal of the first inverter; and
a first output inverter connected to the first capacitor and the output terminal of the first inverter, and
wherein an output of the output inverter is the output clock signal and an output of the first output inverter is the reference clock signal.

30. The digital power converter of claim 29, wherein
the third transistor and the fourth transistor are N channel transistors, and the second voltage is higher than the first voltage.

31. The digital power converter of claim 30, wherein
the output delay is generated when the capacitor is charged by a source current flowing through the third transistor according to the output voltage, and
the reference delay is generated when the first capacitor is charged by a source current flowing through the fourth transistor according to the reference voltage.

32. The digital power converter of claim 29, wherein
the third transistor and the fourth transistor are P channel transistors, and the second voltage is lower than the first voltage.

33. The digital power converter of claim 32, wherein
the output delay is generated when the capacitor is discharged by a sink current flowing through the third transistor according to the output voltage, and
the reference delay is generated when the first capacitor is discharged by a sink current flowing through the fourth transistor according to the reference voltage.

34. A driving method of a digital power converter transforming from an input voltage to an output voltage, the driving method comprising:
generating an output clock signal having an output delay according to the output voltage to a clock signal controlling an operation of the digital power converter;
generating a reference clock signal having a reference delay to the clock signal according to the reference voltage;
generating a phase detection signal according to a phase difference between the output clock signal and the reference clock signal; and
controlling a duty of the power switch according to the phase detection signal.
